(19) United States
(12) Patent Application Publication
(10) Pub. No.: US 2008/0160409 A1
(43) Pub. Date: Jul. 3, 2008

(54) Composite Particle for Electrode, Method for Producing the Same and Secondary Battery

(76) Inventors: Sumihito Ishida, Osaka (JP); Hiroshi Yoshizawa, Osaka (JP); Yasutaka Kogetsu, Osaka (JP); Hiroaki Matsuda, Osaka (JP); Takuma Asari, Hyogo (JP); Takashi Otsuka, Osaka (JP)

Correspondence Address: MCDERMOTT WILL & EMERY LLP, 600 13TH STREET, NW, WASHINGTON, DC, 20005-3096, US

(21) Appl. No.: 11/596,182

(22) PCT Filed: Aug. 23, 2005
(86) PCT No.: PCT/JP2005/015265

§ 371 Date: Nov. 13, 2006

(30) Foreign Application Priority Data
Aug. 26, 2004 (JP) 2004-246397
Feb. 1, 2005 (JP) 2005-025155
Jun. 30, 2005 (JP) 2005-192093

(51) Int. Cl. H01M 4/36; H01M 4/52; H01M 4/50; H01M 4/58; H01M 4/04; B05D 5/12

(52) U.S. Cl. 429/220; 429/231.8; 429/221; 429/223; 429/231.5; 429/224; 427/78

(57) ABSTRACT

A composite particle for an electrode including an active material particle, carbon nanofibers bonded to the surface of the active material particle, and a catalyst element for promoting the growth of the carbon nanofibers, wherein the active material particle includes an electrochemically active phase. As the catalyst element, for example, Au, Ag, Pt, Ru, Ir, Cu, Fe, Co, Ni, Mo, Mn and the like are used. The composite particle for an electrode may be produced, for example, by means of a method which includes: a step of preparing an active material particle including a catalyst element for promoting the growth of carbon nanofibers at least in the surface layer of the active material particle; and a step of growing carbon nanofibers on the surface of the active material particle in an atmosphere including a raw material gas.

### TECHNICAL FIELD

The present invention relates to a chargeable/dischargeable composite particle obtained by improving an active material particle, in particular, an active material particle to the surface of which carbon nanofibers are bonded. Further, the present invention relates to a method for efficiently growing carbon nanofibers on the surface of an active material. Furthermore, the present invention relates to a non-aqueous electrolyte secondary battery and a capacitor each having excellent initial charge/discharge characteristics or cycle characteristics.

### BACKGROUND ART

As electronic devices have been progressively made portable and cordless, there has been growing expectation for non-aqueous electrolyte secondary batteries that are small in size and light in weight and have a high energy density. At present, carbon materials such as graphite come into practical use as negative electrode active materials for non-aqueous electrolyte secondary batteries. Theoretically, graphite can absorb lithium in a proportion of one lithium atom to every 6 carbon atoms. On the other hand, lithium-containing metal oxides such as LiCoO₂, LiNiO₂ and LiMn₂O₄ come into practical use as positive electrode active materials for non-aqueous electrolyte secondary batteries.

Graphite has a theoretical capacity density of 372 mAh/g; however, the actual discharge capacity density is degraded to be approximately 310 to 330 mAh/g because of the losses such as irreversible capacity. It is difficult to obtain a carbon material that can absorb or desorb lithium ions with a capacity density equal to or higher than the above described capacity density. However, batteries having further higher energy densities have been demanded.

Under these circumstances, negative electrode active materials having a theoretical capacity density higher than those of carbon materials have been proposed. Promising among these materials are elementary substances, oxides and the like of the elements (such as Si, Sn and Ge) alloyable with lithium.

However, the elementary substances and oxides of the elements such as Si, Sn and Ge are very low in electronic conductivity, and hence are not practically usable because of being large in internal resistance of batteries unless these active materials are mixed with a conductive material.

Accordingly, the use of fine-particle graphite powder and carbon black as conductive materials has been investigated (Patent Document 1). The use of these conductive materials improves the initial charge/discharge characteristics of batteries.

Si and oxides thereof are particularly poor in conductivity, and hence the carbon coating of the surface of these materials has been proposed. The carbon coating is carried out by CVD (chemical vapor deposition). The carbon coating ensures the electronic conductivity, and reduces the electrode plate resistance before charging (Patent Documents 2 and 3). It has also been proposed to use carbon nanofibers, as a conductive material, known to exhibit high conductivity (Patent Document 4).

It has also been proposed to improve the conductivity within active material particles. For example, it has been proposed to add Cr, B, P and the like to active materials. It has also been proposed to mix carbon nanofibers with active materials with a ball mill (Non-patent Document 1).

As the positive electrode active material of non-aqueous electrolyte secondary batteries, lithium-containing metal oxides have come into practical use. However, the lithium-containing metal oxides are also poor in electronic conductivity, so that in general positive electrodes are formed of material mixtures in which a positive electrode active material and a conductive material are mixed together (Non-patent Document 2). As conductive materials, various carbon species have been investigated. The shape and the addition amount of the carbon species have also been investigated in various ways (Patent Documents 5, 6 and 7).

Examples of the method for synthesizing carbon nanofibers may include the following two methods. One is an arc discharge method in which arc discharge between carbon electrodes grows carbon fibers. It has been reported that arc discharge produces single wall carbon nanotubes (SWNTs) and multiwall carbon nanotubes (MWNTs) each of which is a type of carbon nanofibers. However, at the same time, carbon soot is produced in a large amount in addition to these carbon nanotubes. Consequently, the production efficiency (yield) of the carbon nanotubes becomes very small. Further, the operation for separating the carbon nanotubes from the carbon soot is necessitated so that the arc discharge method is not practical.

The other method is a method in which a mixed gas composed of hydrogen gas and an organic gas is brought into contact with a metal catalyst in a high temperature atmosphere to carry out the vapor-phase growth of carbon nanofibers. The mixing of an organic gas with hydrogen gas is based on the purpose of activating the catalyst. Only with the organic gas, the catalytic activity becomes small to decrease the rate of the conversion of the raw material gas into carbon nanofibers, or the catalyst becomes inactive so that no production of carbon nanofibers can be identified (Non-patent Documents 3 and 4, and Patent Document 8).

There is a related technique in which carbon nanofibers are vapor-phase grown on the surface of an electrode active material that contains a metal or a semimetal; however, the production efficiency of carbon nanofibers is low, and the catalyst tends to be detached away from the surface of the active material. Accordingly, even when electrodes are prepared by using an active material with grown carbon nanofibers, the construction of the electronically conductive network becomes imperfect. Consequently, no expected improvement of the cycle characteristics can be attained in electrochemical elements such as capacitors and secondary batteries (Patent Document 9).

[Patent Document 1]: Japanese Laid-Open Patent Publication No. Hei 4-188560

[Patent Document 2]: Japanese Laid-Open Patent Publication No. 2002-42806

[Patent Document 3]: Japanese Laid-Open Patent Publication No. 2004-47404

[Patent Document 4]: Japanese Laid-Open Patent Publication No. 2003-77476

[Patent Document 5]: Japanese Laid-Open Patent Publication No. Sho 60-65462

[Patent Document 6]: Japanese Laid-Open Patent Publication No. Hei 4-190561

[Patent Document 7]: Japanese Laid-Open Patent Publication No. Hei 4-215252

[Patent Document 8]: Japanese Laid-Open Patent Publication No. 2001-196064

[Patent Document 9]: Japanese Laid-Open Patent Publication No. 2004-349056

[Non-patent Document 1]: “Electrochemistry,” 2003, Vol. 71. No. 12, pp. 1105-1107.

[Non-patent Document 2]: Kiyoshi Kanamura (Ed.), “Technologies for Lithium Secondary Batteries in 21st Century,” CMC Publishing Co., Ltd., pp. 125-128.

[Non-patent Document 3]: Michio Inagaki, “Carbonaceous Material Technologies,” Nikkan Kogyo Shimbun Ltd., Dec. 23, 1987, pp. 72-76.

[Non-patent Document 4]: Sumio Iijima et al., “Carbon Nanotubes,” CMC Publishing Co., Ltd., Nov. 10, 2001, pp. 1-25.

### DISCLOSURE OF THE INVENTION

### Problems to be Solved by the Invention

As described above, as electrode active materials, substitutes for carbon materials have been investigated. However, such substitutes are poor in conductivity, no satisfactory charge/discharge characteristics can be obtained when used each alone. Accordingly, use of conductive materials has been proposed for the purpose of constructing electronically conductive network, and carbon coating of the surface of active materials has also been proposed.

However, such substitutes for carbon materials repeat the alloying reaction with lithium and the lithium releasing reaction in the charge/discharge cycles. Consequently, the active material particles repeat expansion and contraction to gradually destruct the electronically conductive network between the particles. Thus, the internal resistance in a battery is increased to make it difficult to realize satisfactory cycle characteristics.

Even when an element such as Cr, B or P is added to the active material, the electronically conductive network between the active material particles is gradually destructed. Even when the active material and carbon nanofibers are mixed together with a ball mill, the electronically conductive network between the active material particles is gradually destructed. Consequently, no satisfactory cycle characteristics can be obtained.

Lithium-containing metal oxides are also poor in conductivity, and consequently use of various carbon species as conductive materials has been proposed. However, the lithium-containing metal oxides repeat the lithium insertion reaction and the lithium releasing reaction when the charge/discharge cycle is being operated. Consequently, the active material particles repeat expansion and contraction to gradually destruct the electronically conductive network between the particles. Thus, it is difficult to realize an excellent high output discharge characteristics and an excellent cycle characteristics. Further, there is a large density difference between a conductive material and a lithium-containing metal oxide. Consequently, it is very difficult to homogeneously mix the lithium-containing metal oxide and a conductive material.

When carbon nanofibers are grown on the surface of an active material, the arc discharge method thermally melts or modifies the active material as the case may be, and is inefficient because of difficult separation of carbon soot.

When carbon nanofibers are vapor-phase grown on the surface of an electrode active material that contains a metal or a semimetal, the active material is required to support the catalyst element. Accordingly, the active material is soaked in an aqueous or organic solution containing the catalyst element, and then dried to remove the solvent.

In these solutions, sulfates, nitrates, chlorides and the like of the catalyst element are dissolved. However, these salts are sublimed in a high temperature atmosphere. Accordingly, it is necessary, as a preliminary operation, to heat treat these salts in an oxygen-containing atmosphere for the purpose of converting these salts into metal oxides free from sublimation. Further, the metal oxides are required to be reduced into metallic states, before the synthesis of carbon nanofibers, in a high temperature atmosphere by using a large amount of hydrogen gas. Thus, a large amount of hydrogen gas is needed and the rate of the conversion of the raw material gas into carbon nanofibers is degraded.

If the step of converting a salt of a catalyst metal into a metal oxide is omitted, no growth of carbon nanofibers is found, or the rate of the conversion of the raw material gas into carbon nanofibers becomes extremely small. On the other hand, the step of converting a salt into a metal oxide or the step of reducing a metal oxide into a metallic state tends to exfoliate the catalyst element supported on the surface of the active material. As a result, carbon nanofibers not bonded to the active material are produced. Consequently, even when an electrode is prepared by using a composite particle with grown carbon nanofibers, the construction of the electronically conductive network becomes imperfect. Accordingly, the charge/discharge characteristics and the cycle characteristics of capacitors, secondary batteries and the like are degraded.

When a large amount of hydrogen gas and a catalyst species are present in a reaction vessel heated to a high temperature, severe constraints are imposed on the material of the reaction vessel. Predominantly, there is used quartz that is inert both to hydrogen gas and to the catalyst species. However, quartz is problematic in workability, so that it is difficult to make the apparatus large in size.

On the other hand, for example, a stainless steel (SUS) reaction vessel is low in price and can be easily made large in size. However, the SUS component reacts with the organic gas, so that the application of SUS to the reaction vessel is difficult.

A carbon reaction vessel is excellent in that it is highly resistant to hydrogen reduction. However, in the simultaneous presence of hydrogen gas and the catalyst, the hydrogenation reaction or the gasification reaction of carbon proceeds to result in deterioration of the reaction vessel.

### Means for Solving the Problems

The composite particle for an electrode of the present invention includes an active material particle, carbon nanofibers bonded to the surface of the active material particle, and a catalyst element for promoting the growth of the carbon nanofibers. The active material particle includes an electrochemically active phase.

The composite particle for an electrode can be obtained by growing carbon nanofibers on the surface of the active material particle which surface includes the catalyst element.

The composite particle for an electrode may include other components in addition to the active material particle, the carbon nanofibers and the catalyst element, as long as the other components do not impair the function of the composite particle for an electrode. Examples of such other components may include a conductive polymer. The composite particle for an electrode may include only the active material particle, carbon nanofibers and a catalyst element.

The catalyst element is preferably at least one selected from the group consisting of Au, Ag, Pt, Ru, Ir, Cu, Fe, Co, Ni, Mo and Mn.

The catalyst element is preferably present in a state of a metal particle and/or a metal oxide particle (catalyst particle) of 1 nm to 1000 nm in particle size. In other words, the catalyst particle may be in a state of a metal particle or in a state of a metal oxide particle. Alternatively, the catalyst particle may be a particle including a metal and a metal oxide. Two or more types of catalyst particles may be used in combination. The particle size of a catalyst particle can be measured on the basis of the SEM observation, the TEM observation or the like.

The catalyst particles are located in the surface layer of the active material particle and/or the free end of the carbon nanofibers. In other words, the present invention includes a case where the catalyst element is located at least in the surface layer of the active material particle, and a case where the catalyst element is supported at the growth end of the carbon nanofibers. In the latter case, the catalyst element may also be located in the surface layer of the active material particle. Further, the catalyst element may be located inside the active material particle.

At least one end of the carbon nanofibers is bonded to the surface of the active material particle without any resin component. Specifically, the carbon nanofibers are bonded to the active material particle wherein bonding occurs on the surface of the active material particle which surface serves as the starting point of the growth of the carbon nanofibers. The carbon nanofibers are chemically bonded, at least at the one end thereof to be the starting point of the growth thereof, onto the surface of the active material particle. The growth end of the carbon nanofibers is usually a free end. However, both ends of the carbon nanofibers may be bonded to the surface of the active material particle.

When the catalyst element is not extracted from the active material particle despite the growth of the carbon nanofibers, the catalyst element is located at the fixed end of the carbon nanofibers. In other words, the catalyst element is located at the site of bonding between the carbon nanofibers and the active material particle. In this case, there is obtained a composite particle for an electrode which particle is in the condition that the catalyst element is supported by the active material particle.

When the catalyst element is extracted from the active material particle as the carbon nanofibers grow, the catalyst element is located at the tip of the carbon nanofibers, namely, the free end thereof. In this case, there is obtained a composite particle for an electrode which particle is in the condition that one end of the carbon nanofibers is bonded to the surface of the active material particle, and the other end of the carbon nanofibers supports the catalyst element.

In the composite particle for an electrode, the carbon nanofibers having the catalyst element at the fixed end thereof and the carbon nanofibers having the catalyst element at the free end thereof may be present concomitantly with each other. Additionally, the carbon nanofibers having the catalyst element at the fixed end thereof and the carbon nanofibers having the catalyst element at the free end thereof may be simultaneously bonded to one active material particle.

It is desired that the catalyst element display satisfactory catalytic action until the growth of the carbon nanofibers are completed. For that purpose, the catalyst element is preferably present, in a metallic state, in the surface layer of the active material particle and/or at the free end of the carbon nanofibers. On the other hand, after the growth of the carbon nanofibers has been completed, the metallic particles made of the catalyst element are preferably oxidized.

The fiber length of the carbon nanofibers is, for example, 1 nm to 1 mm. From the viewpoint of improving the electronic conductivity of the composite particle, the carbon nanofibers preferably include fine fibers of 1 nm to 40 nm in fiber diameter, and more preferably simultaneously include fine fibers of 1 nm to 40 nm in fiber diameter and large fibers of 40 to 200 nm in fiber diameter. The fiber length and the fiber diameter can be measured on the basis of the SEM observation, the TEM observation or the like.

The carbon nanofibers preferably include at least one selected from the group consisting of tubular carbon, accordion-shaped carbon, plate-shaped carbon and herringbone-shaped carbon. The carbon nanofibers may exclusively include at least one selected from the above described group, or may include carbon nanofibers in other conditions.

The composite particle for an electrode of the present invention can be classified into the following categories A to C.

[A] The electrochemically active phase of the composite particle for an electrode belonging to the category A includes, for example, a compound, an alloy or an elementary substance of at least one metal or semimetal element selected from the group consisting of the elements of the 3B, 4B and 5B groups in the periodic table.

Here, the compound is preferably at least one selected from the group consisting of an oxide, a nitride, an oxynitride, a carbide and a sulfide. When the electrochemically active phase includes at least an oxide, the oxide is preferably amorphous. The alloy is preferably an alloy of a semimetal element and a transition metal element from the viewpoint of improving the electronic conductivity of the composite particle.

Examples of the metal or semimetal elements belonging to the 3B, 4B and 5B groups in the periodic table may include Al, Si, Ga, Ge, Ir, Sn, Sb, Tl, Pb and Bi. Preferred among these are Si, Sn, Ge and the like from the viewpoint of obtaining a high energy density material. When the metal or semimetal element is at least one selected from the group consisting of Si, Sn and Ge, the compound is preferably at least one selected from the group consisting of an oxide, a nitride and an oxynitride. Examples of such an oxide may include SnO, SnO₂, GeO, GeO₂, PbO and SbO₂.

It is more preferable to use the compounds (such as an oxide, a nitride, an oxynitride, a carbide and a sulfide) including a semimetal element than to use the elementary substance of a semimetal element. The reason for that is as follows.

For example, Si, a semimetal element, has an ability of absorbing lithium, and hence is regarded as promising as a high capacity active material. However, the reaction in which elementary silicon electrochemically absorbs and desorbs lithium is accompanied with an extremely complex change in crystal structure. As the reaction proceeds, the composition and the crystal structure of Si varies between Si (crystal structure: Fd3m), LiSi (crystal structure: I4₁/a), Li₂Si (crystal structure: C2/m), Li₇Si₂ (Pbam) and Li₂₂Si₅ (F23). The complex changes in the crystal structure expand the volume of Si by a factor of approximately 4. Consequently, as the charge/discharge cycle is repeated, the destruction of the active material particle proceeds. Additionally, the formation of bonds between lithium and silicon impairs the lithium-absorbing sites initially possessed by silicon, resulting in marked degradation of the cycle life.

For the above described problems, there has also been proposed the application of microcrystalline silicon or amorphous silicon. However, such an application provides only an effect that the destruction of the active material particle due to expansion is suppressed to some extent. Consequently, such an application cannot suppress the destruction of the lithium-absorbing sites caused by the bonding between silicon and lithium.

On the other hand, in the case of silicon oxide, the silicon atom is covalently bonded to the oxygen atom. Accordingly, for the purpose of bonding Si to lithium, it is necessary to break the covalent bond between the silicon atom and the oxygen atom. Consequently, even the insertion of lithium tends to suppress the destruction of the silicon oxide framework. In other words, it is interpreted that the reaction between silicon oxide and Li proceeds while the silicon oxide framework is being maintained. As for the compounds of the other semimetal elements, similar effects can be expected.

In particular, the oxides, nitrides and sulfides are advantageous also in the sense that the catalyst element can be immobilized without fail on the surface of the active material particle. This is conceivably because the oxygen, nitrogen or sulfur atoms located on the surface of the active material particle is bonded to the catalyst element. Further, it is interpreted that the electron attracting effect of the oxygen, nitrogen or sulfur atoms located on the surface of the active material particle improves the reduction performance of the catalyst element into a metal, and consequently, a high catalytic activity can be obtained even under mild reduction conditions.

When an electrochemically active phase other than oxides is used, it is preferable to form an oxide layer on the surface of the active material particle. In other words, as an active material particle, there can also be used a particle that has a core formed of the elementary substance of at least one metal or semimetal element selected from the group consisting of the elements of the 3B, 4B and 5B groups in the periodic table, and an oxide layer covering the surface of the core. For example, there can be preferably used an active material particle that has a core formed of elemental silicon and a silicon oxide (SiO or SiO₂) layer covering the surface of the core. From the viewpoint of attaining the effect of suppressing the destruction of the active material particle, the thickness of the oxide layer is preferably 5 to 20 nm. For example, a baking of silicon oxide in air for 0.5 hour or more makes it possible to form an oxide layer having an appropriate thickness.

[B] The electrochemically active phase of the composite particle for an electrode belonging to the category B includes, for example, at least one metal element selected from the group consisting of Cu, Fe, Co, Ni, Mo and Mn. Examples of such an electrochemically active phase may include a lithium-containing transition metal oxide having a layered structure (for example, R3m). In such a lithium-containing transition metal oxide, the oxygen preferably forms a cubic closest packing configuration. Examples of the lithium-containing transition metal oxide may include those oxides such as LiCoO₂ and LiNiO₂ represented by LiₓM_{1-y}L_{y}O₂ with the proviso that 0<x≦1.2 and 0≦y≦1, the element M is at least one selected from the group consisting of Co and Ni, and the element L is at least one selected from the group consisting of Al, Mn, Mg, Ti, Cr, Fe, Nb, Mo, Ta, Zr and Sr. Olivine compounds such as LiFePO₄ and LiCoPO₄ may also be used.
[C] The examples of the electrochemically active phase of the composite particle for an electrode belonging to the category C may include RuO₂, MoO₂ and Al₂O₃.

The composite particle for an electrode belonging to the category A is suitable as the negative electrode material of a non-aqueous electrolyte secondary battery. The composite particle for an electrode belonging to the category B is suitable as the positive electrode material of a non-aqueous electrolyte secondary battery. The composite particle for an electrode belonging to the category C is suitable as the electrode material of an electrochemical capacitor.

The present invention also relates to a method for producing a composite particle for an electrode which method includes: a step A of preparing an active material particle comprising an electrochemically active phase and having, at least on the surface thereof, a catalyst element for promoting the growth of carbon nanofibers; a step B of growing the carbon nanofibers on the surface of the active material particle in an atmosphere including a carbon-containing gas; and a step C of baking the active material particle with the carbon nanofibers bonded thereto at 400° C. or higher and 1600° C. or lower in an inert gas atmosphere.

The step A includes, for example, a step of supporting, on the surface of the particle formed of an electrochemically active phase, a particle (catalyst particle) formed of at least one metal element selected from the group consisting of Au, Ag, Pt, Ru, Ir, Cu, Fe, Co, Ni, Mo and Mn.

The step A includes, for example, a step of reducing the surface of the particle formed of the electrochemically active phase including at least one metal element selected from the group consisting of Cu, Fe, Co, Ni, Mo and Mn.

The step A includes, for example, a step of synthesizing a particle of an alloy of at least one metal or semimetal element selected from the group consisting of the elements of the 3B, 4B and 5B groups in the periodic table and at least one metal element selected from the group consisting of Cu, Fe, Co, Ni, Mo and Mn.

The production method of the present invention preferably includes a step of further heat treating in air, after the step C, the composite particle at 100° C. or higher and 400° C. or lower. This step can oxidize the catalyst element. A heat treatment carried out at 100° C. or higher and 400° C. or lower can oxidize only the metal element without oxidizing the carbon nanofibers.

The production method of the present invention particularly prefers, for example, a case in which the catalyst element is Ni, the carbon-containing gas is ethylene, and the carbon nanofibers are of a herringbone shape. This is ascribable to the fact that the herringbone-shaped carbon is formed of a low crystalline carbon, and hence is high in flexibility and easily alleviates the expansion and contraction of the active material associated with the charge/discharge operation.

The present invention further relates to a non-aqueous electrolyte secondary battery that includes a positive electrode capable of charging/discharging lithium, a negative electrode including a composite particle belonging to the category A and a non-aqueous electrolyte.

The present invention further relates to a non-aqueous electrolyte secondary battery that includes a positive electrode including a composite particle belonging to the category B, a negative electrode capable of charging/discharging lithium and a non-aqueous electrolyte.

The present invention further relates to a non-aqueous electrolyte secondary battery that includes a positive electrode including a composite particle belonging to the category B, a negative electrode including a composite particle belonging to the category A and a non-aqueous electrolyte.

The present invention further relates to an electrochemical capacitor that includes a pair of polarizable electrodes each including a composite particle belonging to the category C, a separator interposed between the two electrodes and an aqueous or non-aqueous electrolyte.

The present invention also relates to a method for producing a composite particle for an electrode which method includes a step of supporting on the surface of the active material a catalyst element for promoting the growth of carbon nanofibers and a step of growing the carbon nanofibers on the surface of the active material by bringing the active material that supports the catalyst element into contact with a raw material gas, wherein the active material includes an oxide, the raw material gas includes a carbon-containing gas or a mixed gas composed of a carbon-containing gas and hydrogen gas, the carbon-containing gas is at least one selected from the group consisting of carbon monoxide (CO), a saturated hydrocarbon gas represented by CₙH₂ₙ₊₂ (n≧1), an unsaturated hydrocarbon gas represented by CₙH₂ₙ (n≧2) and an unsaturated hydrocarbon gas represented by CₙH₂ₙ₋₂ (n≧2), and the content of the hydrogen gas accounts for less than 5% by volume of the mixed gas composed of the carbon-containing gas and hydrogen gas.

The active material preferably includes an oxide at least on the surface layer thereof.

The oxide constituting the active material is mainly a metal oxide.

The catalyst element may be supported at least on the surface layer of the active material.

In the step of growing the carbon nanofibers on the surface of the active material, for example, the raw material gas and the active material that supports the catalyst element are introduced into the reaction vessel, and the temperature inside the reaction vessel is maintained at 400 to 750° C. Consequently, there are grown the carbon nanofibers in a state of being bonded to the surface of the active material.

For the reaction vessel, there may be used at least one material selected from the group consisting of cast iron, carbon (for example, graphite or glassy carbon) and alumina. Particularly preferred among these are cast iron and carbon because of high workability.

When the active material that supports the catalyst element is brought into contact with the raw material gas, it is efficient to bring the active material that supports the catalyst element in a state of a salt or a compound into contact with the raw material gas.

The production method of the present invention includes: a step of supporting, for example, at least one catalyst element selected from the group consisting of Au, Ag, Pt, Ru, Ir, Cu, Fe, Co, Ni, Mo and Mn, for example, in a state of a salt or a compound, on the active material including an oxide at least on the surface thereof; and a step of growing the carbon nanofibers on the surface of the active material by introducing the raw material gas that may include less than 5% by volume of hydrogen gas and also by introducing the active material that supports the catalyst element into the reaction vessel maintained at 400 to 750° C.

The present invention also relates to an electrochemical capacitor that includes a pair of polarizable electrodes each including an active material prepared according to any one of the above described methods, a separator interposed between the two electrodes and an aqueous or non-aqueous electrolyte. The electrochemical capacitor includes an electric double layer capacitor, a redox capacitor and the like. The polarizable electrode includes a ruthenium oxide electrode, a manganese oxide electrode and the like.

The present invention further relates to a secondary battery that includes a positive electrode, a negative electrode, a separator interposed between the two electrodes and a non-aqueous electrolyte, wherein at least one of the positive and negative electrodes includes an active material prepared according to any one of the above described methods. The secondary battery includes a lithium ion secondary battery and the like.

The active material means a material capable of electrochemically storing the electric capacity, namely, a material formed of an electrochemically active phase. The active material is usually in a state of powder, granular material, flake or the like.

The catalyst element means an element, mainly in a metallic state, having an activity for growing the carbon nanofibers. The salts or the compounds of the catalyst element are, for example, a sulfate, a nitrate, a chloride and the like; specific examples of such salts and compounds may include nickel nitrate, cobalt nitrate, iron nitrate, nickel chloride, cobalt chloride, iron chloride, nickel sulfate, cobalt sulfate, iron sulfate, nickel hydroxide, cobalt hydroxide, iron hydroxide, nickel carbonate, cobalt carbonate, iron carbonate, nickel acetate, cobalt acetate, iron acetate, nickel oxide, cobalt oxide and iron oxide.

### EFFECTS OF THE INVENTION

In the composite particle for an electrode of the present invention, carbon nanofibers are bonded to the surface of the active material particle. Accordingly, an electrode including the composite particle for an electrode is high in electronic conductivity, there is thereby obtained a battery having excellent initial charge/discharge characteristics. Even when the active material particle repeats expansion and contraction, the contact between the carbon nanofibers and the active material particle is constantly maintained. Accordingly, the use of the composite particle for an electrode of the present invention provides a battery excellent in charge/discharge cycle characteristics.

The carbon nanofibers serve as a buffer layer to absorb the stress caused by the expansion and contraction of the active material particle. Accordingly, buckling is suppressed even in an electrode group formed by winding the positive electrode and the negative electrode with a separator interposed therebetween. The cracking of current collectors caused by buckling is also suppressed.

It is conceivable that among the carbon nanofibers grown by gas phase reaction are some carbon nanofibers that electrochemically insert and extract lithium.

When the active material is an oxide, the oxygen element present in the active material and the catalyst element are bonded to each other through the intermolecular forces, ionic bonding or the like. Consequently, the sublimation of the sulfate, nitrate, chloride or the like of the catalyst element in advance of the growth start of the carbon nanofibers can be suppressed, and the catalyst element is immobilized on the surface of the active material without fail. Accordingly, the conversion of the sulfate, nitrate, chloride and the like into the metal oxide can be omitted.

When the active material is an oxide, the electron-attracting effect of the oxygen atoms on the surface of the active material makes it possible to reduce the catalyst element to the metallic state only by controlling the temperature even in an atmosphere of a low concentration of hydrogen or in an atmosphere not containing hydrogen gas. Consequently, the content of the carbon-containing gas in the raw material gas can be increased, and hence the rate of the conversion of the raw material gas into carbon nanofibers is dramatically improved. In other words, when the active material is an oxide, a simple process makes it possible to drastically improve the rate of the conversion of the raw material gas into carbon nanofibers, and a reaction vessel formed of a material other than quartz can also be used. Thus, the reaction apparatus can easily be made larger in size.

### BRIEF DESCRIPTION OF THE DRAWINGS

FIG. 1 is a schematic view illustrating the structure of a composite particle of the present invention;

FIG. 2 is a schematic view illustrating the structure of another composite particle of the present invention;

FIG. 3 is a 500-fold magnified SEM photograph of the surface of a composite particle obtained in Example 1;

FIG. 4 is a 50000-fold magnified SEM photograph of an essential portion of the surface of a composite particle obtained in Example 1; and

FIG. 5 is a 30000-fold magnified SEM photograph of an essential portion of the surface of a composite particle obtained in Example 1.

### BEST MODE FOR CARRYING OUT THE INVENTION

The composite particle for an electrode of the present invention includes an active material particle, carbon nanofibers bonded to the surface of the active material particle and a catalyst element for promoting the growth of the carbon nanofibers.

The active material particle is formed of an electrochemically active phase. The active material particle is more preferably formed of a single particle rather than a granulated body formed of two or more particles. A single particle hardly undergoes, at the time of charge/discharge, the collapse caused by the expansion and contraction. From the viewpoint of suppressing the cracking of the particle as completely as possible, the mean particle size of the active material particle formed of a single particle is preferably 1 to 20 μm. A granulated body formed of two or more particles comes to be larger in particle size than the above described range, and hence sometimes collapses by undergoing the stress of the expansion and contraction at the time of charge/discharge.

No particular constraint is imposed on the catalyst element; however, there may preferably be used at least one selected from the group consisting of Au, Ag, Pt, Ru, Ir, Cu, Fe, Co, Ni, Mo and Mn. When the catalyst element is located on the outermost surface of an active material particle, the catalyst element is preferably in a metallic state or a state of an oxide.

The catalyst element is preferably present in a metallic state until the growth of the carbon nanofibers is completed for the purpose that the catalyst element brings out a satisfactory catalytic action. Usually, the catalyst element is present preferably in a state of a metal particle or an oxide particle (catalyst particle) of 1 nm to 1000 nm in particle size, and more preferably in a state of a catalyst particle of 10 to 100 nm in particle size.

The catalyst element in a metallic state provides an active site for growing the carbon nanofibers. In other words, when an active material particle on the surface of which the catalyst element is exposed in a metallic state is introduced into a high temperature atmosphere that contains a raw material gas for the carbon nanofibers, the growth of the carbon nanofibers proceeds. When no catalyst element is present on the surface of the active material particle, no growth of carbon nanofibers is found.

As the carbon nanofibers grow, the catalyst element may be detached from the surface layer of the active material particle. If this is the case, there is obtained a composite particle in a state that the catalyst particle is supported at the tip, namely, the free end of the carbon nanofibers.

The carbon nanofibers having the catalyst element in the surface layer of the active material particle, namely, at the fixed end of the carbon nanofibers and the carbon nanofibers having the catalyst element at the free end thereof may be present concomitantly with each other.

When the carbon nanofibers have been grown directly on the surface of an active material particle, the bond between the surface of the active material particle and the carbon nanofibers does not involve the intermediary of a resin component such as a binder, but is nothing else than a chemical bond. Accordingly, the resistance to the current collection in a battery becomes small to ensure a high electronic conductivity. Thus, satisfactory initial charge/discharge characteristics can be expected.

Even if repetition of the charge/discharge cycle in a battery causes the expansion and contraction of the active material particle, the connection between the carbon nanofibers and the surface of the active material is maintained. Consequently, the electronically conductive network hardly suffers damage. Thus, the composite particle of the present invention can provide a battery that is excellent in charge/discharge characteristics, high output discharge characteristics, cycle characteristics and the like.

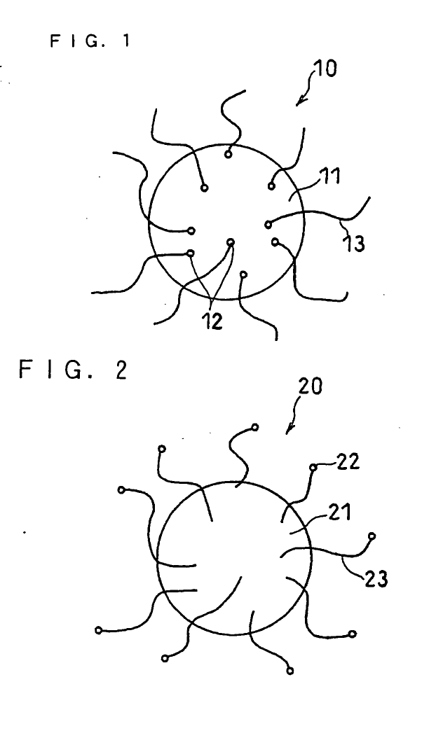

FIG. 1 is a schematic view illustrating the structure of an example of the composite particle for an electrode of the present invention.

The composite particle 10 includes the active material particle 11, the catalyst particle 12 located on the surface of the active material particle 11 and the carbon nanofibers 13 grown with the catalyst particle 12 as the starting point. Such a composite particle is obtained when the catalyst element is not detached from the active material particle even when the carbon nanofibers have been grown. In this case, the catalyst particle is located at the bonding site between the surface of the active material particle and the carbon nanofibers, namely, at the fixed end of the carbon nanofibers.

FIG. 2 is a schematic view illustrating the structure of another example of the composite particle for an electrode of the present invention.

The composite particle 20 includes the active material particle 21, the carbon nanofibers 23 one end of which is bonded to the surface of the active material particle 21 and the catalyst particle 22 supported at the other end of the carbon nanofibers 23. Such a composite particle is obtained when the catalyst particle is detached from the surface layer of the active material particle as the carbon nanofibers are grown. In this case, the catalyst particle is located at the tip, namely, the free end of the carbon nanofibers.

The catalyst particles 12 and 22 each are formed of a catalyst element, and each act as a catalyst to grow carbon nanofibers. The mean particle size of each of the active material particles 11 and 21 is not particularly limited, but is preferably 1 to 20 μm.

The method for disposing catalyst particles on the surface of an active material particle is not particularly limited, but preferable examples of such a method may include a method (method 1) in which catalyst particles are supported on the surface of a particle formed of an electrochemically active phase, and a method (method 2) in which the surface of an active material particle that contains a catalyst element is reduced to produce the catalyst particles on the surface of the active material particle.

Method 1 can be applied to any particle as long as the particle is formed of an electrochemically active phase. Method 2 can be applied only to an active material particle that contains a catalyst element.

In the case of method 1 in which the catalyst particles are supported on the surface of a particle comprising an electrochemically active phase, it is possible to mix solid catalyst particles with particles comprising an electrochemically active phase. However, preferable is a method in which particles comprising an electrochemically active phase are soaked in a solution of a metal compound to be a raw material for the catalyst particle. The solvent is removed from the particles having been soaked in the solution, and a heat treatment is applied, if needed. In this way, it is possible to obtain an active material particle that supports on the surface thereof the catalyst particles of 1 nm to 1000 nm, preferably 10 to 100 nm in particle size uniformly and in a highly dispersed state.

It is very difficult to make the particle size of a catalyst particle smaller than 1 nm. On the other hand, when the particle size of a catalyst particle exceeds 1000 nm, the size of the catalyst particle becomes extremely nonuniform. Accordingly, it becomes sometimes difficult to grow carbon nanofibers, or electrodes excellent in conductivity sometimes cannot be obtained.

Examples of the metal compounds for obtaining solutions may include nickel nitrate hexahydrate, cobalt nitrate hexahydrate, iron nitrate nonahydrate, copper nitrate trihydrate, manganese nitrate hexahydrate and hexaammonium heptamolybdate tetrahydrate; however, such metal compounds are not limited to these examples.

The solvents for the solutions are selected in consideration of the solubilities of the compounds and the compatibility of the solvents with the electrochemically active phases. Suitable solvents are selected among, for example, water, organic solvents and mixtures composed of water and organic solvents. As organic solvents, there may be used, for example, ethanol, isopropyl alcohol, toluene, benzene, hexane, tetrahydrofuran and the like.

In the case of method 2, an active material particle that contains a catalyst element, namely, a lithium-containing metal oxide such as LiCoO₂, LiNiO₂ or LiMn₂O₄ is heated under an atmosphere of a gas having a reducing power such as hydrogen. In this way, a particle of a metal such as Co, Ni or Mn can be produced on the surface of the active material particle. Also in this case, control of the reducing conditions makes it possible to produce catalyst particles of 1 nm to 1000 nm, preferably 10 nm to 100 nm in particle size, in the surface layer of the active material particle.

As method 3, an alloy particle that contains a catalyst element is synthesized and the alloy particle can be used as an active material particle. In this case, an alloy of at least one metal or semimetal element selected from the group consisting of the elements of the 3B, 4B and 5B groups in the periodic table and the catalyst element is synthesized by means of a common alloy producing method. The metal or semimetal element selected from the elements of the 3B, 4B and 5B groups in the periodic table electrochemically reacts with Li to produce a Li alloy, and hence an electrochemically active phase is formed. On the other hand, at least a part of a metal phase comprising the catalyst element comes to be exposed, for example, in a state of particles of 10 nm to 100 nm in particle size, on the surface of the alloy particle.

The amount of the catalyst particle (in an alloy, the metal phase formed of the catalyst element) is preferably 0.01% by weight to 10% by weight of the amount of the active material particle, and more preferably 1% by weight to 3% by weight. When the amount of the catalyst particle or the metal phase formed of the catalyst element is too small, sometimes it takes a long time to grow carbon nanofibers, resulting in degrading the production efficiency. On the other hand, when the amount of the catalyst particle or the metal phase comprising the catalyst element is too large, the agglomeration of the catalyst element results in growing of carbon nanofibers that are nonuniform and large in fiber diameter. This leads to the degradation of the conductivity and the active material density of the electrodes. Additionally, the proportion of the electrochemically active phase becomes relatively smaller, sometimes to make it difficult to apply the composite particle as a high-capacity electrode material.

The fiber length of the carbon nanofibers is preferably 1 nm to 1 mm, and more preferably 500 nm to 500 μm. When the fiber length of the carbon nanofibers is less than 1 nm, sometimes the effect of increasing the electrode conductivity becomes too small. On the other hand, when the fiber length exceeds 1 mm, the active material density and the capacity of the electrodes tend to be small. The fiber diameter of the carbon nanofibers is preferably 1 nm to 1000 nm, and more preferably 50 nm to 300 nm.

A part of the carbon nanofibers is preferably composed of fine fibers of 1 nm to 40 nm in fiber diameter from the viewpoint of improving the electronic conductivity of the composite particle. For example, fine fibers of 40 nm or less in fiber diameter and large fibers of 50 nm or more in fiber diameter are preferably included simultaneously, and fine fibers of 30 nm or less in fiber diameter and large fibers of 80 nm or more in fiber diameter are more preferably included simultaneously.

The amount of the carbon nanofibers to be grown on the surface of the active material particle is preferably 5 parts by weight to 150 parts by weight, and more preferably 10 to 100 parts by weight, per 100 parts by weight of the active material particle. When the amount of the carbon nanofibers is too small, sometimes effects of improving the electrode conductivity and improving the charge/discharge characteristics and the cycle characteristics of a battery cannot be sufficiently attained. Also when the amount of the carbon nanofibers is too large, the active material density and the capacity of the electrodes become small, although there are no problems from the viewpoints of the electrode conductivity, and the charge/discharge characteristics and the cycle characteristics of a battery.

Next, description will be made on the conditions for growing carbon nanofibers on the surface of an active material particle.

When an active material particle that contains a catalyst element at least in the surface layer thereof is introduced into a high temperature atmosphere that contains a raw material gas for the carbon nanofibers, the growth of the carbon nanofibers proceeds. For example, the active material particle is placed in a ceramic reaction vessel, and the temperature is elevated to high temperatures of 100 to 1000° C., preferably 300 to 600° C. in an inert gas or a gas having a reducing power. Thereafter, a raw material gas for the carbon nanofibers is introduced into the reaction vessel. When the temperature inside the reaction vessel is lower than 100° C., the growth of the carbon nanofibers does not occur or is too slow, and hence the productivity is impaired. When the temperature inside the reaction vessel exceeds 1000° C., decomposition of the reaction gas is promoted, and hence the production of the carbon nanofibers becomes difficult.

Preferred as the raw material gas is a mixed gas composed of a carbon-containing gas and hydrogen gas. As the carbon-containing gas, there may be used carbon element-containing gases such as methane, ethane, ethylene, butane, carbon monoxide and acetylene. The mixing ratio of the carbon-containing gas to hydrogen gas is preferably 2:8 to 8:2 in terms of molar ratio (volume ratio). When the catalytic element in a metallic state is not exposed on the surface of the active material particle, the proportion of the hydrogen gas is controlled to be large to some extent. In this way, the reduction of the catalyst element and the growth of the carbon nanofibers can be made to proceed simultaneously. On the other hand, when the active material includes an oxide, the proportion of the hydrogen gas may be small, and a raw material gas that contains no hydrogen gas can also be used.

When the growth of the carbon nanofibers is terminated, the mixed gas composed of a carbon-containing gas and hydrogen gas is replaced with an inert gas, and the interior of the reaction vessel is cooled down to room temperature.

Subsequently, the active material particle with the carbon nanofibers bonded thereto is baked in an inert gas atmosphere at 400° C. or higher and 1600° C. or lower, for example, for 30 minutes to 2 hours. Thus, there can be suppressed the irreversible reaction between the electrolyte and the carbon nanofibers that proceeds at the time of initial charging of the battery, and an excellent charge/discharge efficiency can be attained.

When such a baking step is not carried out, or the baking temperature is lower than 400° C., the above described irreversible reaction cannot be suppressed and sometimes the charge/discharge efficiency of a battery is degraded. When the baking temperature exceeds 1600° C., there proceeds a reaction between the electrochemically active phase of the active material particle and the carbon nanofibers. Consequently, the active phase is deactivated, or the electrochemically active phase is reduced, to sometimes cause the degradation of the capacity. For example, when the electrochemically active phase of the active material particle is formed of Si, Si and the carbon nanofibers react with each other to produce inactive silicon carbide, and the degradation of the charge/discharge capacity of a battery is caused. Additionally, the lithium-containing oxides known as the positive electrode active materials are sometimes thermally reduced at temperatures exceeding 1000° C.

For example, the baking temperature for the lithium-containing oxides is particularly preferably 700° C. or higher and 1000° C. or lower; the baking temperature for Si is particularly preferably 1000° C. or higher and 1600° C. or lower.

The composite particle that has been baked in an inert gas is preferably further heat treated in air at 100° C. or higher and 400° C. or lower for the purpose of oxidizing at least a part (for example, the surface) of the metal particle or the metal phase formed of the catalyst element. When the heat treatment temperature is lower than 100° C., it is difficult to oxidize the metal. When the heat treatment temperature exceeds 400° C., sometimes the grown carbon nanofibers are burnt.

When the composite particle is used as an electrode material without oxidizing the metal particle or the metal phase formed of the catalyst element, in particular, Ni or Cu is dissolved at an oxidation potential of 3 V or more. The dissolved element is reduced and deposited on the negative electrode to possibly cause battery failure. By heat treating the composite particle at temperatures of 100° C. or higher and 400° C. or lower, exclusively the metal particle or the metal phase can be oxidized to an appropriate extent without oxidizing the carbon nanofibers, and thus such battery failure as described above can be suppressed.

The carbon nanofibers may incorporate the catalyst element into the interior thereof in the course of the growth thereof. The carbon nanofibers grown on the surface of the active material particle sometimes include carbon nanofibers in a tubular state, an accordion-shaped state, a plate-shaped state and a herringbone-shaped state. Particularly preferred among these are the carbon nanofibers in a herringbone-shaped state that is an amorphous state. The carbon nanofibers in a herringbone-shaped state are low in the crystallinity of carbon, and hence are flexible and high in the ability to alleviate the stress caused by the expansion of the active material particle.

When the carbon nanofibers in a herringbone-shaped state are grown, it is preferable that, for example, a copper-nickel alloy (the molar ratio of copper to nickel being 3:7) is used as catalyst, and the reaction is carried out at temperatures of 550 to 650° C. Ethylene gas or the like is preferably used as the carbon-containing gas in the raw material gas. The mixing ratio of the carbon-containing gas to hydrogen gas is preferably, for example, 2:8 to 8:2 in terms of molar ratio (volume ratio); the preferable range of the mixing ratio may be interpreted to depend on the type of the active material.

When carbon nanofibers in a tubular state are grown, it is preferable that, for example, an iron-nickel alloy (the molar ratio of iron to nickel being 6:4) is used as catalyst and the reaction is carried out at temperatures of 600 to 700° C. Carbon monoxide or the like is preferably used as the carbon-containing gas in the raw material gas. The mixing ratio of the carbon-containing gas to hydrogen gas is preferably, for example, 2:8 to 8:2 in terms of molar ratio (volume ratio); the preferable range of the mixing ratio may be interpreted to depend on the type of the active material.

When carbon nanofibers in a plate-shaped state are grown, it is preferable that, for example, iron is used as catalyst, and the reaction is carried out at temperatures of 550 to 650° C. Carbon monoxide or the like is preferably used as the carbon-containing gas in the raw material gas. The mixing ratio of the carbon-containing gas to hydrogen gas is preferably, for example, 2:8 to 8:2 in terms of molar ratio (volume ratio); the preferable range of the mixing ratio may be interpreted to depend on the type of the active material.

It is to be noted that carbon nanofibers in a tubular state and carbon nanofibers in a plate-shaped state are higher in crystallinity than carbon nanofibers in a herringbone-shaped state, and consequently suitable for highly densifying electrode plates.

Next, description will be made on the electrodes for non-aqueous electrolyte secondary batteries that contain the above described composite particles.

For example, common electrodes to be used in cylindrical or rectangular non-aqueous electrolyte secondary batteries are obtained by machining to predetermined shapes the electrode plates in which electrode material mixtures are supported on current collectors. The electrode material mixtures usually each include a composite particle and a resin binder as the essential components. The electrode material mixtures each may include a conductive material, a thickener and the like as the optional components as long as these optional components do not significantly impair the advantageous effects of the present invention. As the binder, there are used fluorocarbon resins such as polyvinylidene fluoride (PVDF), rubber-like resins such as styrene-butadiene rubber (SBR), and rubber-like resins that contain the acrylic acid, acrylonitrile, or acrylate units. As the conductive material, carbon black and the like are preferably used. As the thickener, carboxymethyl cellulose (CMC) and the like are preferably used.

The electrode material mixture is mixed with a liquid component to be converted into a slurry. The slurry thus obtained is coated on both sides of a current collector, and then dried. Thereafter, the electrode material mixture supported on the current collector is rolled together with the current collector and the rolled product is cut to a predetermined size to yield an electrode. The method described herein is only an example, and the electrode may be fabricated by any other methods. The type and shape of the electrode are not limited in such a way that a composite particle can also be used for electrodes of coin-shaped batteries.

An electrode group is constructed by using the obtained electrode, a counter electrode and a separator. For the separator, microporous film made of polyolefin resin is preferably used, but no particular constraint is imposed on the separator.

The electrode group is housed together with a non-aqueous electrolyte in a battery case. For the non-aqueous electrolyte, there is generally used a non-aqueous solvent in which a lithium salt is dissolved. No particular constraint is imposed on the lithium salt, but for example, LiPF₆, LiBF₄ and the like are preferably used. No particular constraint is imposed on the non-aqueous solvent, but there are preferably used, for example, carbonic acid esters such as ethylene carbonate, propylene carbonate, dimethyl carbonate, diethyl carbonate and ethyl methyl carbonate.

When the active material includes an oxide, the rate of the conversion of the raw material gas into the carbon nanofibers can be drastically improved by reducing the hydrogen gas concentration in the raw material gas. When the raw material gas dose not include hydrogen gas or includes hydrogen gas in a low concentration, a reaction vessel formed of a material, other than quartz, excellent in workability and handlability can be used. Thus, the reaction apparatus can easily be made larger in size.

In the following, description will be made on a preferable production method of a composite particle in the case where the active material includes an oxide.

As the raw material gas, there is used a carbon-containing gas or a mixed gas composed of a carbon-containing gas and hydrogen gas. The raw material gas may be mixed with an inert carrier gas. When the mixed gas composed of a carbon-containing gas and hydrogen gas is used, the content of the hydrogen gas is set to account for less than 5% by volume of the mixed gas. When the content of the hydrogen gas is 5% by volume or more, the hydrogenation reaction of carbon proceeds with the aid of the catalyst to result in gasification. Thus, the production efficiency of the carbon nanofibers is degraded.

The carbon-containing gas is at least one selected from the group consisting of carbon monoxide (CO), a saturated hydrocarbon gas represented by CₙH₂ₙ₊₂ (n≧1), an unsaturated hydrocarbon gas represented by CₙH₂ₙ (n≧2) and an unsaturated hydrocarbon gas represented by CₙH₂ₙ₋₂ (n≧2). However, the carbon-containing gas preferably includes at least an unsaturated hydrocarbon gas. The use of a hydrocarbon containing an unsaturated bond makes it possible to remarkably improve the production efficiency of the carbon nanofibers in an atmosphere having a low hydrogen gas concentration or in an atmosphere that does not contain hydrogen gas.

For example, ethane, which is a saturated hydrocarbon, starts a polymerization reaction in a high-temperature atmosphere, and hydrogen gas is generated concomitantly with the polymerization reaction. The hydrogen gas thus generated reduces the catalyst element, or decomposes the pyrocarbon (pyrolytic carbon) adhered to the catalyst element by hidrogenation. Accordingly, it is interpreted that even when the hydrogen concentration in the raw material gas is extremely small or hydrogen is not contained in the raw material gas, the raw material gas is efficiently decomposed and the carbon nanofibers are produced in a high efficiency.

An unsaturated hydrocarbon is also assumed to act similarly. However, for example, when ethylene, which is an unsaturated hydrocarbon, is polymerized, the produced polymer includes unsaturated bonds. Consequently, it is interpreted that graphene sheet is more easily grown, as compared to a saturated hydrocarbon gas, and the production rate of the carbon nanofibers is drastically improved.

As the saturated hydrocarbon represented by CₙH₂ₙ₊₂ (n≧1), there can be used, for example, methane, ethane, propane, butane, pentane, heptane and the like. For the saturated hydrocarbons, n preferably satisfies the relation 1≦n≦5.

As the unsaturated hydrocarbon represented by CₙH₂ₙ (n≧2) or by CₙH₂ₙ₋₂ (n≧2), there can be used, for example, ethylene, acetylene, propene, allene, propyne, butene, methylpropene, butadiene and the like. For the unsaturated hydrocarbons, n preferably satisfies the relation 2≦n≦5.

When it is intended to increase the production rate of the carbon nanofibers, an unsaturated hydrocarbon is preferably used. When it is intended to accurately control the production amount of the carbon nanofibers, at least one selected from saturated hydrocarbons and carbon monoxide is preferably used although the production rate is decreased. Even in the case where at least one selected from saturated hydrocarbons and carbon monoxide and an unsaturated hydrocarbon are used in combination, when it is intended to accurately control the production amount of the carbon nanofibers, the proportion of the former (a saturated hydrocarbon or carbon monoxide) is preferably made larger; when it is intended to increase the production rate of the carbon nanofibers, the proportion of the latter (an unsaturated hydrocarbon) is preferably made larger.

The active material, namely, a material capable of electrochemically storing electric capacity, includes an oxide. In the case of the negative electrode active material for a lithium ion secondary battery, there can be used as the oxide, metal oxides and semimetal oxides such as SiO, SnO, SnO₂, GeO and GeO₂, but the oxide is not limited to these examples.

In the case of the positive electrode active material for a lithium ion secondary battery, there can be used as the oxide, lithium-transition metal composite oxides such as LiCoO₂, LiNiO₂ and LiMn₂O₄, but the oxide is not limited to these examples.

In the case of the active material for the polarizable electrode of an electrochemical capacitor, there can be used as the oxide, transition metal oxides such as RuO₂ and MnO₂, but the oxide is not limited to these examples.

The active material need not be wholly formed of an oxide. Only the surface layer of the active material may include an oxide. For example, materials (for example, Si, Sn, Ge and the like) capable of electrochemically storing electric capacity can be used through heat treatment in an oxygen atmosphere. The heat treatment produces an oxide-containing active material in the surface layer of the material.

As the catalyst element for promoting the growth of the carbon nanofibers, there is preferably used one selected from the group consisting of Au, Ag, Pt, Ru, Ir, Cu, Fe, Co, Ni, Mo and Mn.

No particular constraint is imposed on the method for supporting the catalyst element on the surface of the active material, but the impregnation method is preferable. In the impregnation method, the active material is immersed in an aqueous or organic solution dissolving a salt (for example, a nitrate, a sulfate, a chloride and the like) that contains the catalyst element or a compound that contains the catalyst element; and thereafter only the solvent component is removed. The removal of the solvent can be carried out with a device such as an evaporator. On the basis of such a method as described above, the catalyst element can be uniformly supported, in a state of a nitrate, a sulfate, a chloride or the like, on the surface of the active material.

Examples of the salts or the compounds that contain the catalyst element may include nickel nitrate hexahydrate, cobalt nitrate hexahydrate, iron nitrate nonahydrate, copper nitrate trihydrate, manganese nitrate hexahydrate and hexaammonium heptamolybdate tetrahydrate. Preferred among these are the nitrates.

The solvent for the solution is selected as appropriate from water, organic solvents, mixtures composed of water and an organic solvent, and the like. As the organic solvents, there can be used, for example, ethanol, isopropyl alcohol, toluene, benzene, hexane, tetrahydrofuran and the like.

The catalyst element is preferably supported in an amount of 0.01 to 10 parts by weight, and more preferably 1 to 3 parts by weight per 100 parts by weight of the active material.

Next, illustration will be made on the procedures and conditions for the growth of the carbon nanofibers on the surface of an active material that contains an oxide.

First, the active material that supports the catalyst element is introduced into a high temperature atmosphere that contains a raw material gas. For example, in a quartz reaction vessel, an active material that supports a catalyst element is placed, and is increased in temperature to 400 to 750° C., preferably 500 to 600° C. in an inert gas. Thereafter, a raw material gas for the carbon nanofibers is introduced into the reaction vessel and the temperature inside the reaction vessel is maintained at 400 to 750° C., preferably 500 to 600° C. When the temperature inside the reaction vessel is lower than 400° C., sometimes the growth of the carbon nanofibers becomes too slow and the productivity is impaired. When the temperature inside the reaction vessel exceeds 750° C., sometimes decomposition of the raw material gas is promoted and the production of the carbon nanofibers is inhibited.

When the growth of the carbon nanofibers is terminated, the raw material gas is replaced with an inert gas, and the interior of the reaction vessel is cooled down to room temperature. The amount of the carbon nanofibers to be grown on the surface of the active material is preferably 5 to 150 parts by weight per 100 parts by weight of the active material (a material capable of electrochemically storing electric capacity). When the amount of the carbon nanofibers is too small, sometimes effects of improving the electrode conductivity and improving the charge/discharge characteristics and the cycle characteristics of a battery cannot be sufficiently attained. Also when the amount of the carbon nanofibers is too large, the active material density of the electrodes and the capacity of the battery become small, although there are no problems from the viewpoints of the electrode conductivity, and the charge/discharge characteristics and the cycle characteristics of the battery.

As the material for the reaction vessel, there is preferably used carbon (for example, graphite or glassy carbon), cast iron, alumina and the like. Quartz can also be used as the material for the reaction vessel, but has drawback in workability. When quartz is used, it is difficult to make the reaction vessel larger in size, and hence it becomes difficult to improve the productivity. On the other hand, carbon, cast iron, alumina and the like are high in heat resistance and excellent in workability, and scarcely react with the carbon-containing gas even when exposed to high temperature atmosphere.

In the following, specific description will be made on the present invention on the basis of Examples and Comparative Examples, but following Examples only exemplify a part of the embodiments of the present invention and the present invention is not limited to these Examples.

### EXAMPLE 1

In 100 g of ion-exchanged water, 1 g of nickel nitrate hexahydrate (guaranteed grade) manufactured by Kanto Chemical Co., Inc. was dissolved. The solution thus obtained was mixed with 100 g of silicon particles (Si) pulverized to 10 μm or less, manufactured by Kojundo Chemical Laboratory Co., Ltd. The mixture was stirred for 1 hour, and then the water was removed with an evaporator. Consequently, there was obtained an active material particle formed of the silicon particle that constitutes the electrochemically active phase and nickel nitrate supported on the surface of the silicon particle.

The silicon particles that support nickel nitrate were placed in a ceramic reaction vessel, and the temperature was increased to 550° C. in the presence of helium gas. Then, the helium gas was replaced with a mixed gas composed of 50% by volume of hydrogen gas and 50% by volume of methane gas, and the interior of the reaction vessel was maintained at 550° C. for 3 hours. Consequently, tubular carbon nanofibers of approximately 80 nm in fiber diameter and 500 nm in fiber length were grown on the surface of the silicon particles. Then, the mixed gas was replaced with helium gas and the interior of the reaction vessel was cooled down to room temperature. The amount of the grown carbon nanofibers was 100 parts by weight per 100 parts by weight of the active material particles.

The nickel nitrate supported on the silicon particles was found to be reduced to particles of approximately 100 nm in particle size. The particle size of the nickel particles, the fiber diameter and the fiber length were respectively observed by means of a SEM. The weight of the carbon nanofibers was measured from the weight variation of the active material particles between before and after the growth of the carbon nanofibers. The SEM observations identified the presence of fine fibers of 30 nm or less in fiber diameter in addition to fibers of approximately 80 nm in fiber diameter.

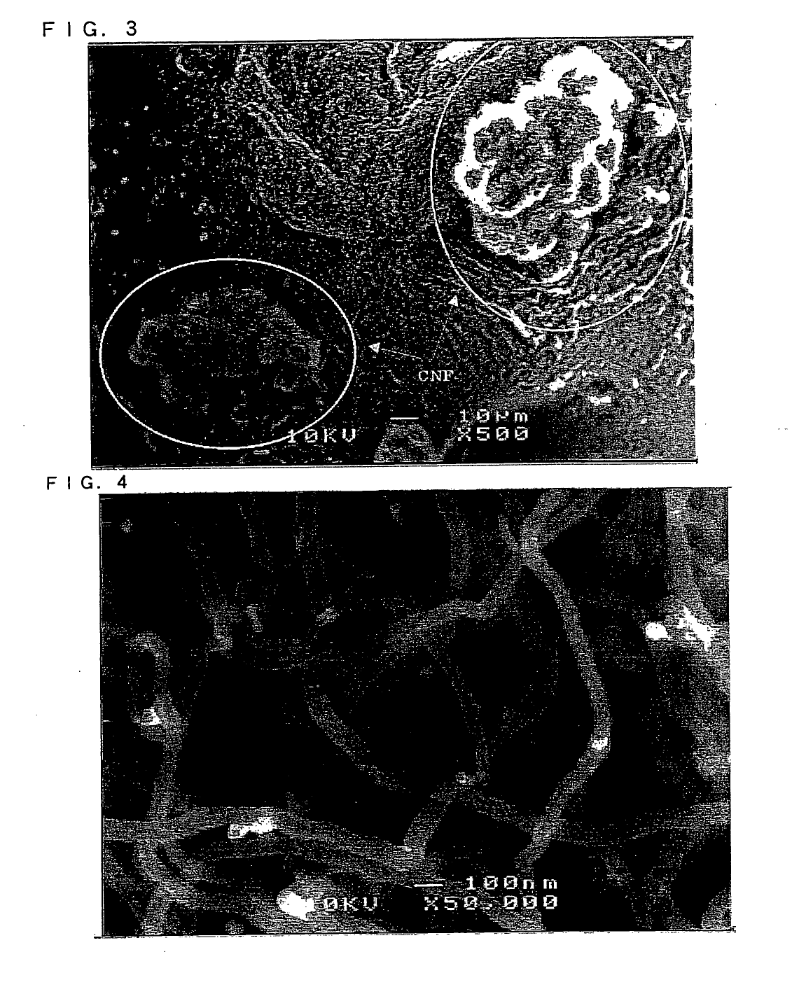

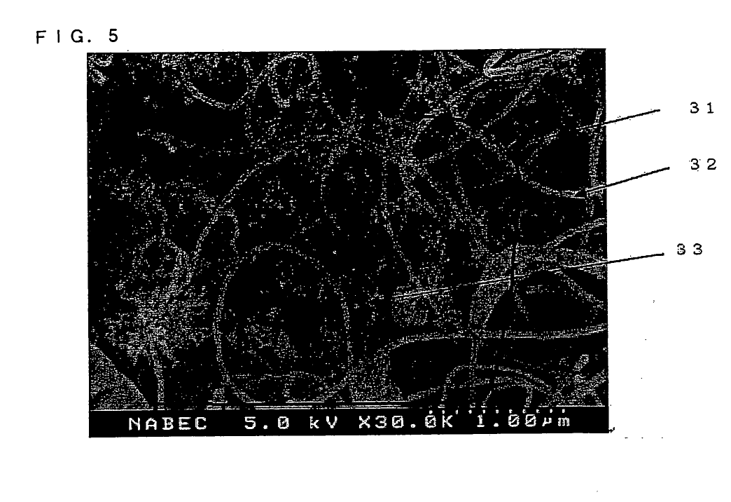

FIG. 3 shows a 500-fold magnified photograph of the obtained composite particle. FIG. 4 shows a 50000-fold magnified photograph of the circled region in FIG. 3. From FIG. 4, the growth of the carbon nanofibers in the circled region can be identified. FIG. 5 shows a 30000-fold magnified photograph of the obtained composite particle. In FIG. 5, the presence of large carbon nanofibers 32 and fine carbon nanofibers 33 on the surface of the active material particle 31 can be observed.

Thereafter, the composite particle was increased in temperature to 1000° C. in argon gas, and the composite particle was baked at 1000° C. for 1 hour to prepare an electrode material A for a non-aqueous electrolyte secondary battery.

### EXAMPLE 2

An electrode material B for a non-aqueous electrolyte secondary battery was prepared by carrying out the same operations as in Example 1 except that 1 g of cobalt nitrate hexahydrate (guaranteed grade) manufactured by Kanto Chemical Co., Inc. was dissolved in 100 g of ion-exchanged water in place of 1 g of nickel nitrate hexahydrate. The particle size of the cobalt particles supported on the silicon particles was approximately the same as that of the nickel particles in Example 1. The fiber diameter, the fiber length, and the weight proportion to the active material particle of the grown herringbone-shaped carbon nanofibers were approximately the same as those in Example 1. Also in this Example, the SEM observations identified the presence of fine fibers of 30 nm or less in fiber diameter in addition to fibers of approximately 80 nm in fiber diameter.

### EXAMPLE 3

Silicon particles (20% by weight) pulverized to 10 μm or less and nickel particles (80% by weight) pulverized to 10 μm or less manufactured by Kanto Chemical Co., Inc. were mixed together. Shear stress was applied to the mixture thus obtained by means of the mechanical alloying method to prepare Ni—Si alloy particles having a mean particle size of 20 μm. An electrode material C for a non-aqueous electrolyte secondary battery was prepared by carrying out the same operations as in Example 1 except that the Ni—Si alloy particles thus obtained were used in place of the silicon particles. The particle size of the nickel particles supported on the Ni—Si alloy particles was the same as that of the nickel particles in Example 1. The fiber diameter, the fiber length, and the weight proportion to the active material particle of the grown tubular carbon nanofibers were approximately the same as those in Example 1. Also in this Example, the SEM observations identified the presence of fine fibers of 30 nm or less in fiber diameter in addition to fibers of approximately 80 nm in fiber diameter.

### EXAMPLE 4

An electrode material D for a non-aqueous electrolyte secondary battery was prepared by carrying out the same operations as in Example 1 except that 0.5 g of nickel nitrate hexahydrate and 0.5 g of cobalt nitrate hexahydrate were dissolved in 100 g of ion-exchanged water in place of 1 g of nickel nitrate hexahydrate. The particle size of the cobalt particles and the particle size of the nickel particles supported on the silicon particles were respectively approximately the same as that of the nickel particles in Example 1. The fiber diameter, the fiber length, and the weight proportion to the active material particle of the grown tubular carbon nanofibers were approximately the same as those in Example 1. Also in this Example, the SEM observations identified the presence of fine fibers of 30 nm or less in fiber diameter in addition to fibers of approximately 80 nm in fiber diameter.

### EXAMPLE 5

An electrode material E for a non-aqueous electrolyte secondary battery was prepared by carrying out the same operations as in Example 1 except that the growth time of the carbon nanofibers in the mixed gas composed of 50% by volume of hydrogen gas and 50% by volume of methane gas was altered to 5 minutes. The grown carbon nanofibers were found to have a fiber length of approximately 0.5 nm and a fiber diameter of approximately 80 nm. The amount of the grown carbon nanofibers was 1 part by weight or less per 100 parts by weight of the active material particles.

### EXAMPLE 6

An electrode material F for a non-aqueous electrolyte secondary battery was prepared by carrying out the same operations as in Example 1 except that the growth time of the carbon nanofibers in the mixed gas composed of 50% by volume of hydrogen gas and 50% by volume of methane gas was altered to 20 hours. The grown carbon nanofibers were found to have a fiber length of approximately 3 mm or more and a fiber diameter of approximately 80 nm. The amount of the grown carbon nanofibers was 200 parts by weight per 100 parts by weight of the active material particles. Also in this Example, the SEM observations identified the presence of fine fibers of 30 nm or less in fiber diameter in addition to fibers of approximately 80 nm in fiber diameter.

### EXAMPLE 7

An electrode material G for a non-aqueous electrolyte secondary battery was prepared by carrying out the same operations as in Example 1 except that the baking treatment of the composite particles after the growth of the carbon nanofibers was carried out at 100° C.

### EXAMPLE 8

An electrode material H for a non-aqueous electrolyte secondary battery was prepared by carrying out the same operations as in Example 1 except that the baking treatment of the composite particles after the growth of the carbon nanofibers was carried out at 1700° C.

### COMPARATIVE EXAMPLE 1

An electrode material I for a non-aqueous electrolyte secondary battery was prepared by dry mixing 100 parts by weight of silicon particles pulverized to 10 μm or less with 10 parts by weight of acetylene black (AB) as a conductive material.

### COMPARATIVE EXAMPLE 2

In 100 g of ion-exchanged water, 1 g of nickel nitrate hexahydrate was dissolved. The solution thus obtained was mixed with 5 g of acetylene black (AB). The mixture thus obtained was stirred for 1 hour, then the water was removed with an evaporator, and thus the nickel particles were supported on the acetylene black. Then, the acetylene black that supports the nickel particles was baked at 300° C. in air to yield nickel oxide particles of 0.1 μm or less in particle size.

The nickel oxide particles thus obtained were placed in a ceramic reaction vessel, and were increased in temperature to 550° C. in the presence of helium gas. Thereafter, the helium gas was replaced with a mixed gas composed of 50% by volume of hydrogen gas and 50% by volume of methane gas, and the interior of the reaction vessel was maintained at 550° C. for 3 hours. Consequently, there were obtained tubular carbon nanofibers of approximately 80 nm in fiber diameter and approximately 500 μm in fiber length. Then, the mixed gas was replaced with helium gas and the interior of the reaction vessel was cooled down to room temperature.

The carbon nanofibers (CNF) thus obtained were washed with a hydrochloric acid aqueous solution to remove the nickel particles, and thus carbon nanofibers that did not contain the catalyst element were obtained. Then, 100 parts by weight of the carbon nanofibers and 100 parts by weight of silicon particles pulverized to 10 μm or less were dry mixed to prepare an electrode material J for a non-aqueous electrolyte secondary battery.

### COMPARATIVE EXAMPLE 3

Silicon particles pulverized to 10 μm or less were placed in a ceramic reaction vessel, and the temperature was increased to 1000° C. in the presence of helium gas. Thereafter, the helium gas was replaced with a mixed gas composed of 50% by volume of benzene gas and 50% by volume of helium gas, and the interior of the reaction vessel was maintained at 1000° C. for 1 hour. Consequently, an approximately 500 nm thick carbon layer was formed on the surface of the silicon particles. Then, the mixed gas was replaced with helium gas, the interior of the reaction vessel was cooled down to room temperature, and thus, an electrode material K for a non-aqueous electrolyte secondary battery was obtained.

### COMPARATIVE EXAMPLE 4

To 100 parts by weight of silicon particles, 0.02 part by weight of a chromium powder manufactured by Kanto Chemical Co., Inc. was added. The mixture thus obtained was mixed for 10 hours with a ball mill to yield chromium-containing silicon particles. Thereafter, 70 parts by weight of the chromium-containing silicon particles and 30 parts by weight of the same carbon nanofibers as used in Comparative Example 2 were mixed together with a ball mill to pulverize the silicon particles to 10 μm or less.

The mixture thus obtained was placed in a ceramic reaction vessel, and was increased in temperature to 700° C. in the presence of helium gas. Thereafter, the helium gas was replaced with methane gas (100% by volume), and the interior of the reaction vessel was maintained at 700° C. for 6 hours. Consequently, an approximately 100 nm thick carbon layer was formed on the surface of the silicon particles. Then, the methane gas was replaced with helium gas, and the interior of the reaction vessel was cooled down to room temperature to prepare an electrode material L for a non-aqueous electrolyte secondary battery.

### [Evaluations]

Each of the electrode materials prepared in Examples 1 to 8 and Comparative Examples 1 to 4 was mixed with a binder made of a vinylidene fluoride resin and with N-methyl-2-pyrrolidone (NMP) to prepare a material mixture slurry. The slurry was cast on a 15 μm thick Cu foil and dried; thereafter the material mixture was rolled to yield an electrode plate. The material mixture density of each of the obtained electrode plates was 0.8 to 1.4 g/cm³.

The electrode plates were sufficiently dried in an oven set at 80° C. to yield working electrodes. By using a lithium metal foil as the counter electrode for each of the working electrodes, coin-shaped lithium ion batteries each regulated in capacity by the working electrode were prepared. As the non-aqueous electrolyte, there was used an electrolyte in which LiPF₆ was dissolved in a concentration of 1.0 M (mol/L) in a 1:1 (volume ratio) mixed solvent of ethylene carbonate and diethyl carbonate.

Each of the coin-shaped lithium ion batteries thus obtained was subjected to the measurements of the initial charge capacity and the initial discharge capacity at a charge/discharge rate of 0.05 C, and thus the initial discharge capacity per the weight of the active material was obtained. Further, the ratio of the initial discharge capacity to the initial charge capacity was obtained in terms of percentage to be defined as the charge/discharge efficiency.

At a charge/discharge rate of 0.05 C, 50 charge/discharge cycles were repeated. The ratio of the discharge capacity after the 50 charge/discharge cycles to the initial discharge capacity was obtained in terms of percentage to be defined as the cycle efficiency. The results thus obtained are shown in Table 1.

TABLE 1

| | | | | | | Discharge | Charge/ | |
|---|---|---|---|---|---|---|---|---|
| | Electrode | | | Baking | Conductive | capacity | discharge | Cycle |
| | material | Catalyst | Length | temperature | material | (mAh/g) | efficiency | efficiency |
| Example 1 | A | Ni | 500 μm | 1000° C. | None | 3802 | 85% | 90% |
| Example 2 | B | Co | 500 μm | 1000° C. | None | 3810 | 84% | 89% |
| Example 3 | C | Ni | 500 μm | 1000° C. | None | 750 | 86% | 91% |
| Example 4 | D | NiCo | 500 μm | 1000° C. | None | 3798 | 85% | 90% |
| Example 5 | E | Ni | 0.5 nm | 1000° C. | None | 3780 | 83% | 42% |
| Example 6 | F | Ni | 3 mm | 1000° C. | None | 3805 | 85% | 92% |
| Example 7 | G | Ni | 500 μm | 100° C. | None | 3790 | 73% | 91% |
| Example 8 | H | Ni | 500 μm | 1700° C. | None | 3150 | 85% | 88% |
| Comparative | I | None | — | Not | AB | 2682 | 60% | 5% |
| Example 1 | | | | applicable | | | | |
| Comparative | J | None | — | Not | CNF | 3129 | 70% | 20% |
| Example 2 | | | | applicable | | | | |
| Comparative | K | None | — | Not | Carbon layer | 2235 | 50% | 15% |
| Example 3 | | | | applicable | | | | |
| Comparative | L | Ni | — | Not | CNF/ | 2692 | 60% | 18% |
| Example 4 | | | | applicable | Carbon layer | | | |

AB: Acetylene black
CNF: Carbon nanofiber

As shown in Table 1, differences due to differences in catalyst types were not identified in the batteries utilizing the electrode materials prepared in Examples 1 to 8. Any of Examples was superior to Comparative Example 1 that did not contain carbon nanofibers, with respect to all of the initial discharge capacity per the weight of the active material, the charge/discharge efficiency and the cycle efficiency. In Comparative Example 1, the electronically conductive network between the surface of the active material particle and the carbon black was disconnected due to the expansion and contraction of the active material caused by charging/discharging, and consequently the cycle characteristics were degraded.

In the battery utilizing the electrode material prepared in Comparative Example 2 by dry mixing the carbon nanofibers with the active material particles, steep degradations were found in the charge/discharge efficiency and the cycle efficiency, as compared to the batteries of Examples 1 to 8. This is ascribable to the fact that the electronically conductive network between the surface of the active material particle and the carbon nanofibers was disconnected due to the expansion and contraction of the active material caused by charging/discharging.

Also in the battery utilizing the electrode material prepared in Comparative Example 3 by coating the surface of the active material particles with a carbon layer, steep degradations were found in the charge/discharge efficiency and the cycle efficiency, as compared to the batteries of Examples 1 to 8. This is ascribable to the fact that the electronically conductive network between the active material particles was disconnected due to the expansion and contraction of the active material caused by charging/discharging.

Also in the battery utilizing the electrode material prepared in Comparative Example 4 by mixing with a ball mill the mixture composed of the active material particles added with chromium and the carbon nanofibers and by coating the surface of the particles with a carbon layer, steep degradations were found in the charge/discharge efficiency and the cycle efficiency, as compared to the batteries of Examples 1 to 8. This is also ascribable to the fact that the electronically conductive network between the active material particles was disconnected due to the expansion and contraction of the active material caused by charging/discharging.

The cycle characteristics of the battery utilizing the composite particles prepared in Example 5 by growing the carbon nanofibers so as to have a length as short as 0.5 nm were degraded as compared to Examples 1 to 4. It is conceivable that the conductivity was maintained in the initial stage owing to the carbon nanofibers formed on the surface of the active material, but the expansion and contraction of the active material were repeated by charging/discharging, so that the conductivity between the particles was gradually impaired.

On the contrary, in the battery utilizing the composite particles prepared in Example 6 by growing the carbon nanofibers so as to be long, all of the initial discharge capacity per the weight of the active material, the charge/discharge efficiency and the cycle efficiency were at the same levels as in Examples 1 to 4. However, the discharge capacity per electrode plate was found to decrease by approximately 67%. This is ascribable to the fact that the proportion of the carbon nanofibers in each of the electrode plates was relatively increased in relation to the amount of the active material.

In the battery utilizing the composite particles prepared in Example 7 by carrying out at 100° C. the baking treatment after the growth of the carbon nanofibers, the initial charge/discharge efficiency was reduced as compared to Examples 1 to 4. This is ascribable to the fact that the baking at 100° C. was not able to remove the hydrogen ions and the functional groups such as methyl groups and hydroxyl groups adhering to the surface of the carbon nanofibers to cause an irreversible reaction with the electrolyte.

In the battery utilizing the composite particles prepared in Example 8 by carrying out at 1700° C. the baking treatment after the growth of the carbon nanofibers, the initial discharge capacity per the weight of the active material was reduced as compared to Examples 1 to 4. In this case, conceivably, the hydrogen ions and the functional groups such as methyl groups and hydroxyl groups adhering to the surface of the carbon nanofibers were perfectly removed. However, a reaction between silicon and carbon occurred to form electrochemically inactive silicon carbide, and consequently, the initial discharge capacity per the weight of the active material was decreased.

### EXAMPLE 9

In a ceramic reaction vessel, LiCoO₂ particles having a mean particle size of 10 μm were placed, and the temperature was increased to 550° C. in the presence of helium gas. Thereafter, the helium gas was replaced with a mixed gas composed of 50% by volume of hydrogen gas and 50% by volume of methane gas, and the interior of the reaction vessel was maintained at 550° C. for 3 hours. Consequently, on the surface of the LiCoO₂ particles, there were grown tubular carbon nanofibers of approximately 80 nm in fiber diameter and approximately 500 μm in fiber length. Then, the mixed gas was replaced with helium gas, and the interior of the reaction vessel was cooled down to room temperature. The amount of the grown carbon nanofibers was 100 parts by weight per 100 parts by weight of the active material particles. The SEM observations identified the presence of fine fibers of 30 nm or less in fiber diameter in addition to the fibers of approximately 80 nm in fiber diameter.

Thereafter, the temperature of the composite particles was increased to 700° C. in argon gas, and the composite particles were baked at 700° C. for 1 hour. Then, the temperature of the composite particles was increased in air to 300° C. and the composite particles were heat treated for 2 hours to prepare an electrode material M for a non-aqueous electrolyte secondary battery.

### EXAMPLE 10

In 100 g of ion-exchanged water, 1 g of nickel nitrate hexahydrate was dissolved. The solution thus obtained was mixed with 100 g of LiCoO₂ particles having a mean particle size of 10 μm. The mixture thus obtained was stirred for 1 hour, and then the water was removed with an evaporator to yield active material particles each composed of a LiCoO₂ particle and nickel nitrate as the inactive layer supported on the surface of the LiCoO₂ particle.

An electrode material N for a non-aqueous electrolyte secondary battery was prepared by carrying out the same operations as in Example 9 except that the active material particles thus obtained were placed in a ceramic reaction vessel and carbon nanofibers were grown on the surface of the active material particles. The grown tubular carbon nanofibers were approximately 80 nm in fiber diameter and approximately 500 μm in fiber length. The weight ratio of the grown carbon nanofibers to the active material particles was approximately the same as that in Example 1. The nickel nitrate supported on the LiCoO₂ particles was found to be reduced to nickel particles of approximately 100 nm in particle size. The SEM observations identified the presence of fine fibers of 30 nm or less in fiber diameter in addition to the fibers of approximately 80 nm in fiber diameter.

### EXAMPLE 11

An electrode material O for a non-aqueous electrolyte secondary battery was prepared by carrying out the same operations as in Example 10 except that LiMn₂O₄ was used in place of the LiCoO₂ particles. The particle size of the nickel particles supported on the LiMn₂O₄ particles was approximately the same as that of the nickel particles in Example 10. The fiber diameter, the fiber length and the weight ratio of the grown carbon nanofibers to the active material particles were approximately the same as those in Example 10. The SEM observations identified the presence of fine fibers of 30 nm or less in fiber diameter in addition to the fibers of approximately 80 nm in fiber diameter.

### EXAMPLE 12

An electrode material P for a non-aqueous electrolyte secondary battery was prepared by carrying out the same operations as in Example 10 except that 0.5 g of nickel nitrate hexahydrate and 0.5 g of cobalt nitrate hexahydrate were dissolve in 100 g of ion-exchanged water in place of 1 g of nickel nitrate hexahydrate. The particle size of the cobalt particles and the particle size of the nickel particles supported on the LiCoO₂ particles were respectively approximately the same as that of the nickel particles in Example 10. The fiber diameter, the fiber length and the weight ratio of the grown tubular carbon nanofibers to the active material particles were approximately the same as those in Example 10. The SEM observations identified the presence of fine fibers of 30 nm or less in fiber diameter in addition to the fibers of approximately 80 nm in fiber diameter.

### EXAMPLE 13

An electrode material Q for a non-aqueous electrolyte secondary battery was prepared by carrying out the same operations as in Example 10 except that the growth time of the carbon nanofibers in the mixed gas composed of 50% by volume of hydrogen gas and 50% by volume of methane gas was altered to 5 minutes. The grown carbon nanofibers were found to have a fiber length of approximately 0.5 nm and a fiber diameter of approximately 80 nm. The amount of the grown carbon nanofibers was 1 part by weight or less per 100 parts by weight of the active material particles. The SEM observations identified the presence of fine fibers of 30 nm or less in fiber diameter in addition to the fibers of approximately 80 nm in fiber diameter.

### EXAMPLE 14

An electrode material R for a non-aqueous electrolyte secondary battery was prepared by carrying out the same operations as in Example 10 except that the growth time of the carbon nanofibers in the mixed gas composed of 50% by volume of hydrogen gas and 50% by volume of methane gas was altered to 20 hours. The grown carbon nanofibers were found to have a fiber length of approximately 3 mm or more and a fiber diameter of approximately 80 nm. The amount of the grown carbon nanofibers was 200 parts by weight per 100 parts by weight of the active material particles. The SEM observations identified the presence of fine fibers of 30 nm or less in fiber diameter in addition to the fibers of approximately 80 nm in fiber diameter.

### EXAMPLE 15

An electrode material S for a non-aqueous electrolyte secondary battery was prepared by carrying out the same operations as in Example 10 except that the baking treatment of the composite particles after the growth of the carbon nanofibers was carried out at 100° C.

### EXAMPLE 16

An electrode material T for a non-aqueous electrolyte secondary battery was prepared by carrying out the same operations as in Example 10 except that the baking treatment of the composite particles after the growth of the carbon nanofibers was carried out at 1500° C.

### COMPARATIVE EXAMPLE 5

An electrode material U for a non-aqueous electrolyte secondary battery was prepared by dry mixing 100 parts by weight of LiCoO₂ particles having a mean particle size of 10 μm with 5 parts by weight of acetylene black (AB) as a conductive material.

### COMPARATIVE EXAMPLE 6

An electrode material V for a non-aqueous electrolyte secondary battery was prepared by dry mixing 5 parts by weight of the same carbon nanofibers as prepared in Comparative Example 2 that did not contain any catalyst element with 100 parts by weight of LiCoO₂ particles having a mean particle size of 10 μm.

### [Evaluations]

Each of the electrode materials prepared in Examples 9 to 16 and Comparative Examples 5 and 6 was mixed with a binder made of a vinylidene fluoride resin and with NMP to prepare a material mixture slurry. The slurry was cast on a 15 μm thick Al foil and dried; thereafter the material mixture was rolled to yield an electrode plate. The material mixture density of each of the obtained electrode plates was 3.3 g/cm³.

The electrode plates were sufficiently dried in an oven set at 80° C. to yield working electrodes. By using a lithium metal foil as the counter electrode for each of the working electrodes, coin-shaped lithium ion batteries each regulated in capacity by the working electrode were prepared. As the non-aqueous electrolyte, there was used an electrolyte in which LiPF₆ was dissolved in a concentration of 1.0 M (mol/L) in a 1:1 (volume ratio) mixed solvent of ethylene carbonate and diethyl carbonate.

Each of the coin-shaped lithium ion batteries thus obtained was subjected to charging/discharging at a rate of 0.2 C, and the initial discharge capacity per the weigh of the active material was obtained.

Further, each of the batteries was charged at a rate of 0.2 C and was discharged at a rate of 1.0 C or 2.0 C; the ratio of the 2.0 C discharge capacity to the 1.0 C discharge capacity was obtained in terms of percentage to be defined as the discharge efficiency.

Further, the initial discharge capacity was obtained at a charge/discharge rate of 1.0 C. Charging/discharging was repeated at a charge/discharge rate of 1.0 C for 200 cycles. Then, the ratio of the discharge capacity after 200 charge/discharge cycles to the initial discharge capacity was obtained in terms of percentage to be defined as the cycle efficiency. The results obtained are shown in Table 2.

TABLE 2

| | | | | | | Discharge | | |
|---|---|---|---|---|---|---|---|---|
| | Electrode | | | Baking | Conductive | capacity | Discharge | Cycle |
| | material | Catalyst | Length | temperature | material | (mAh/g) | efficiency | efficiency |
| Example 9 | M | None | 500 μm | 700° C. | None | 135 | 95% | 93% |
| Example 10 | N | Ni | 500 μm | 700° C. | None | 133 | 95% | 93% |
| Example 11 | O | Ni | 500 μm | 700° C. | None | 97 | 93% | 92% |
| Example 12 | P | NiCo | 500 μm | 700° C. | None | 133 | 95% | 93% |
| Example 13 | Q | Ni | 0.5 nm | 700° C. | None | 130 | 87% | 82% |
| Example 14 | R | Ni | 3 mm | 700° C. | None | 132 | 95% | 94% |
| Example 15 | S | Ni | 500 μm | 100° C. | None | 115 | 85% | 85% |
| Example 16 | T | Ni | 500 μm | 1500° C. | None | 100 | 85% | 90% |
| Comparative | U | None | — | Not | AB | 134 | 82% | 80% |
| Example 5 | | | | applicable | | | | |
| Comparative | V | None | — | Not | CNF | 134 | 81% | 82% |
| Example 6 | | | | applicable | | | | |

AB: Acetylene black
CNF: Carbon nanofiber

As shown in Table 2, in any of the batteries utilizing the electrode materials prepared in Examples 9 to 16, an initial discharge capacity close to a theoretical capacity was obtained irrespective of the types of the active materials and the catalyst. The discharge efficiency and the cycle efficiency were both superior to those in Comparative Examples 5 and 6.

In each of the batteries utilizing the electrode materials prepared in Comparative Examples 5 and 6 by dry mixing a conductive material with LiCoO₂ particles, it is interpreted that the electronically conductive network between the surface of the active material and the conductive material was disconnected due to the expansion and contraction of the LiCoO₂ particles caused by charging/discharging, and consequently the initial discharge efficiency and the cycle characteristics were made poor.

The cycle efficiency of the battery utilizing the composite particles prepared in Example 13 by growing the carbon nanofibers so as to have a length as short as 0.5 nm was extremely degraded as compared to Example 10. It is conceivable that the conductivity was maintained in the initial stage owing to the carbon nanofibers formed on the surface of the active material, but the expansion and contraction of the active material were repeated by charging/discharging, so that the conductivity between the particles was gradually impaired.

On the contrary, in the battery utilizing the composite particles prepared in Example 14 by growing the carbon nanofibers so as to be long, all of the initial discharge capacity per the weight of the active material, the discharge efficiency and the cycle efficiency were at the same levels as in Example 10. However, the discharge capacity per electrode plate was found to decrease. This is ascribable to the fact that the proportion of the carbon nanofibers in the electrode plates was relatively increased in relation to the amount of the active material.

In the battery utilizing the composite particles prepared in Example 15 by carrying out at 100° C. the baking treatment after the growth of the carbon nanofibers, the discharge efficiency was reduced as compared to Example 10. This is ascribable to the fact that the baking at 100° C. was not able to remove the hydrogen ions and the functional groups such as methyl groups and hydroxyl groups adhering to the surface of the carbon nanofibers to cause an irreversible reaction with the electrolyte.

In the battery utilizing the composite particles prepared in Example 16 by carrying out at 1500° C. the baking treatment after the growth of the carbon nanofibers, the initial discharge capacity per the weight of the active material was reduced as compared to Example 10. In this case, conceivably, the hydrogen ions and the functional groups such as methyl groups and hydroxyl groups adhering to the surface of the carbon nanofibers were perfectly removed. However, LiCoO₂ was decomposed by reduction to produce electrochemically inactive cobalt oxides such as CO₂O₃, and consequently the initial discharge capacity was decreased.

### EXAMPLE 17

An electrode material W for a non-aqueous electrolyte secondary battery was prepared by carrying out the same operations as in Example 1 except that the growth time of the carbon nanofibers in the mixed gas composed of 50% by volume of hydrogen gas and 50% by volume of methane gas was altered to 10 minutes. The grown carbon nanofibers were found to have a fiber length of approximately 500 nm and a fiber diameter of approximately 80 nm. The amount of the grown carbon nanofibers was 5 parts by weight or less per 100 parts by weight of the active material particles.

### EXAMPLE 18

An electrode material X for a non-aqueous electrolyte secondary battery was prepared by carrying out the same operations as in Example 1 except that the growth time of the carbon nanofibers in the mixed gas composed of 50% by volume of hydrogen gas and 50% by volume of methane gas was altered to 30 minutes. The grown carbon nanofibers were found to have a fiber length of approximately 10 μm and a fiber diameter of approximately 80 nm. The amount of the grown carbon nanofibers was 10 parts by weight per 100 parts by weight of the active material particles.

### EXAMPLE 19

An electrode material Y for a non-aqueous electrolyte secondary battery was prepared by carrying out the same operations as in Example 1 except that the growth time of the carbon nanofibers in the mixed gas composed of 50% by volume of hydrogen gas and 50% by volume of methane gas was altered to 60 minutes. The grown carbon nanofibers were found to have a fiber length of approximately 50 μm and a fiber diameter of approximately 80 nm. The amount of the grown carbon nanofibers was 30 parts by weight per 100 parts by weight of the active material particles.

### EXAMPLE 20

An electrode material Z for a non-aqueous electrolyte secondary battery was prepared by carrying out the same operations as in Example 1 except that the growth time of the carbon nanofibers in the mixed gas composed of 50% by volume of hydrogen gas and 50% by volume of methane gas was altered to 90 minutes. The grown carbon nanofibers were found to have a fiber length of approximately 100 μm and a fiber diameter of approximately 80 nm. The amount of the grown carbon nanofibers was 50 parts by weight per 100 parts by weight of the active material particles.

### [Evaluations]

The electrode materials prepared in Examples 17 to 20 were used to prepare coin-shaped lithium ion batteries of the same type as in Example 1, and were evaluated in the same manner as in Example 1. The initial discharge capacities per the weight of the active material, the charge/discharge efficiencies and the cycle efficiencies were obtained. The results thus obtained are shown in Table 3.

TABLE 3

| | | | | | | Discharge | Charge/ | |
|---|---|---|---|---|---|---|---|---|
| | Electrode | | | Baking | Conductive | capacity | discharge | Cycle |
| | material | Catalyst | Length | temperature | material | (mAh/g) | efficiency | efficiency |
| Example 17 | W | Ni | 500 nm | 1000° C. | None | 3800 | 86% | 65% |
| Example 18 | X | Ni | 10 μm | 1000° C. | None | 3805 | 85% | 73% |
| Example 19 | Y | Ni | 50 μm | 1000° C. | None | 3802 | 82% | 89% |
| Example 20 | Z | Ni | 100 μm | 1000° C. | None | 3801 | 84% | 90% |

### EXAMPLE 21

An electrode material a for a non-aqueous electrolyte secondary battery was prepared by carrying out the same operations as in Example 10 except that the growth time of the carbon nanofibers in the mixed gas composed of 50% by volume of hydrogen gas and 50% by volume of methane gas was altered to 10 minutes. The grown carbon nanofibers were found to have a fiber length of approximately 500 nm and a fiber diameter of approximately 80 nm. The amount of the grown carbon nanofibers was 5 parts by weight per 100 parts by weight of the active material particles.

### EXAMPLE 22

An electrode material β for a non-aqueous electrolyte secondary battery was prepared by carrying out the same operations as in Example 10 except that the growth time of the carbon nanofibers in the mixed gas composed of 50% by volume of hydrogen gas and 50% by volume of methane gas was altered to 30 minutes. The grown carbon nanofibers were found to have a fiber length of approximately 10 μm and a fiber diameter of approximately 80 nm. The amount of the grown carbon nanofibers was 10 parts by weight per 100 parts by weight of the active material particles.

### EXAMPLE 23

An electrode material γ for a non-aqueous electrolyte secondary battery was prepared by carrying out the same operations as in Example 10 except that the growth time of the carbon nanofibers in the mixed gas composed of 50% by volume of hydrogen gas and 50% by volume of methane gas was altered to 60 minutes. The grown carbon nanofibers were found to have a fiber length of approximately 50 μm and a fiber diameter of approximately 80 nm. The amount of the grown carbon nanofibers was 30 parts by weight per 100 parts by weight of the active material particles.

### EXAMPLE 24

An electrode material δ for a non-aqueous electrolyte secondary battery was prepared by carrying out the same operations as in Example 10 except that the growth time of the carbon nanofibers in the mixed gas composed of 50% by volume of hydrogen gas and 50% by volume of methane gas was altered to 90 minutes. The grown carbon nanofibers were found to have a fiber length of approximately 100 μm and a fiber diameter of approximately 80 nm. The amount of the grown carbon nanofibers was 50 parts by weight per 100 parts by weight of the active material particles.

### [Evaluations]

The electrode materials prepared in Examples 21 to 24 were used to prepare coin-shaped lithium ion batteries in the same manner as in Example 9, and were evaluated in the same manner as in Example 9. The initial discharge capacities per the weight of the active material, the discharge efficiencies and the cycle efficiencies were obtained. The results thus obtained are shown Table 4.

TABLE 4

| | | | | | | Discharge | | |
|---|---|---|---|---|---|---|---|---|
| | Electrode | | | Baking | Conductive | capacity | Discharge | Cycle |
| | material | Catalyst | Length | temperature | material | (mAh/g) | efficiency | efficiency |
| Example 21 | α | Ni | 500 nm | 700° C. | None | 132 | 95% | 85% |
| Example 22 | β | Ni | 10 μm | 700° C. | None | 131 | 94% | 87% |
| Example 23 | γ | Ni | 50 μm | 700° C. | None | 134 | 95% | 92% |
| Example 24 | δ | Ni | 100 μm | 700° C. | None | 132 | 95% | 93% |

### EXAMPLE 25

In 100 g of ion-exchanged water, 1 g of nickel nitrate hexahydrate (guaranteed grade) manufactured by Kanto Chemical Co., Inc. was dissolved. The solution thus obtained was mixed with 100 g of silicon particles pulverized to 10 μm or less, manufactured by Kojundo Chemical Laboratory Co., Ltd. The mixture was stirred for 1 hour, and then the water was removed with an evaporator. Consequently, there was obtained an active material particle formed of the silicon particle and nickel nitrate supported on the surface of the silicon particle.

The silicon particles that support nickel nitrate were placed in a ceramic reaction vessel, and were increased in temperature to 550° C. in the presence of helium gas. Thereafter, the helium gas was replaced with a mixed gas composed of 20% by volume of hydrogen gas and 80% by volume of ethylene gas, and the interior of the reaction vessel was maintained at 540° C. for 3 hours. Consequently, herringbone-shaped carbon nanofibers of approximately 80 nm in fiber diameter and 500 μm in fiber length were grown on the surface of the silicon particles. Then, the mixed gas was replaced with helium gas and the interior of the reaction vessel was cooled down to room temperature. The amount of the grown carbon nanofibers was 100 parts by weight per 100 parts by weight of the active material particles. Also in this case, the SEM observations identified the presence of fine fibers of 30 nm or less in fiber diameter in addition to fibers of approximately 80 nm in fiber diameter.

### [Evaluation]

The electrode material prepared in Example 25 was used to prepare a negative electrode of the same type as in Example 1. Lithium was imparted onto the negative electrode thus obtained in an amount corresponding to the irreversible capacity by use of a lithium deposition apparatus based on resistance heating.

A positive electrode material mixture slurry was prepared by mixing together 100 parts by weight of LiNi_{0.8}Co_{0.17}Al_{0.03}O₂, 10 parts by weight of a binder made of a polyvinylidene fluoride, 5 parts by weight of carbon black and an appropriate amount of N-methyl-2-pyrrolidone (NMP). The slurry thus obtained was cast on a 15 μm thick Al foil and dried; thereafter the positive electrode material mixture was rolled, and thus a positive electrode material mixture layer was formed to yield a positive electrode.

A battery was prepared in the same manner as in Example 1 except that there were used the thus obtained negative electrode into which lithium was introduced and the thus obtained positive electrode which included LiNi_{0.8}Co_{0.17}Al_{0.03}O₂ as the positive electrode active material, and the battery was evaluated in the same manner as in Example 1. Consequently, the initial discharge capacity per the weight of the negative electrode active material was 3801 mAh/g, the discharge efficiency was 86% and the cycle efficiency was 91%.

The method for introducing lithium into the negative electrode is not limited to the above described method; for example, lithium foil may be adhered onto the negative electrode to thereafter assemble a battery, or a lithium powder may be introduced into the interior of a battery.

### EXAMPLE 26

Silicon particles pulverized to 10 μm or less, manufactured by Kojundo Chemical Laboratory Co., Ltd., were heated in air at 600° C. for 1 hour to form a 20 nm thick silicon oxide layer on the surface of the silicon particles. An electrode material was obtained by carrying out the same operations as in Example 1 except that there were used the silicon particles, each having a silicon oxide layer, obtained as described above. Consequently, there were grown tubular carbon nanofibers of approximately 80 nm in fiber diameter and approximately 500 μm in fiber length on the surface of the silicon particles having a silicon oxide layer. The amount of the grown carbon nanofibers was 100 parts by weight per 100 parts by weight of the active material particles. Also in this case, the SEM observations identified the presence of fine fibers of 30 nm or less in fiber diameter in addition to fibers of approximately 80 nm in fiber diameter.

The electrode material thus obtained was used to prepare a battery in the same manner as in Example 1, and was evaluated in the same manner as in Example 1. Consequently, the initial discharge capacity per the weight of the active material was 3800 mAh/g, the discharge efficiency was 90% and the cycle efficiency was 95%.

### EXAMPLE 27

In present Example, a composite active material that included silicon oxide and carbon nanofibers was prepared by using silicon oxide (SiO) as an active material, Ni as a catalyst element and ethylene gas as a carbon-containing gas, and by adopting the following procedures.

In 100 g of ion-exchanged water, 1 g of nickel nitrate hexahydrate (guaranteed grade) manufactured by Kanto Chemical Co., Inc. was dissolved. The solution thus obtained was mixed with 20 g of silicon oxide pulverized to 10 μm or less in mean particle size, manufactured by Kojundo Chemical Laboratory Co., Ltd. The mixture was stirred for 1 hour, and then the water was removed with an evaporator to support nickel nitrate on the surface of the silicon oxide particles.

The silicon oxide that supports nickel nitrate was placed in a quartz reaction vessel and the temperature was increased to 550° C. in the presence of helium gas. Then, the helium gas was replaced with a mixed gas composed of 2% by volume of hydrogen gas and 98% by volume of ethylene gas, and the interior of the reaction vessel was maintained at 550° C. for 1 hour.

Then, the mixed gas was replaced with helium gas and the interior of the reaction vessel was cooled down to room temperature. The composite particle thus obtained can be used, for example, as a negative electrode material for a non-aqueous electrolyte secondary battery. The composite particle included carbon nanofibers in an amount of approximately 101 parts by weight per 100 parts by weight of silicon oxide. The weight of the carbon nanofibers was measured from the weight variation of the silicon oxide between before and after the growth of the carbon nanofibers.

### EXAMPLE 28

A composite particle that included silicon oxide and carbon nanofibers was prepared by carrying out the same operations as in Example 27 except that ethylene gas (100% by volume) was singly used in place of the mixed gas composed of 2% by volume of hydrogen gas and 98% by volume of ethylene gas.

### EXAMPLE 29

A composite particle that included silicon oxide and carbon nanofibers was prepared by carrying out the same operations as in Example 27 except that a mixed gas composed of 5% by volume of hydrogen gas and 95% by volume of ethylene gas was used in place of the mixed gas composed of 2% by volume of hydrogen gas and 98% by volume of ethylene gas.

### EXAMPLE 30

A composite particle that included silicon oxide and carbon nanofibers was prepared by carrying out the same operations as in Example 27 except that a carbon reaction vessel was used in place of the quartz reaction vessel.

### EXAMPLE 31

A composite particle that included silicon oxide and carbon nanofibers was prepared by carrying out the same operations as in Example 27 except that a cast-iron reaction vessel was used in place of the quartz reaction vessel.

### EXAMPLE 32

A composite particle that included silicon oxide and carbon nanofibers was prepared by carrying out the same operations as in Example 27 except that an aluminum reaction vessel was used in place of the quartz reaction vessel.

### REFERENCE EXAMPLE 1

A composite particle that included silicon oxide and carbon nanofibers was prepared by carrying out the same operations as in Example 27 except that a mixed gas composed of 10% by volume of hydrogen gas and 90% by volume of ethylene gas was used in place of the mixed gas composed of 2% by volume of hydrogen gas and 98% by volume of ethylene gas.

### REFERENCE EXAMPLE 2

A composite particle that included silicon oxide and carbon nanofibers was prepared by carrying out the same operations as in Example 27 except that a mixed gas composed of 50% by volume of hydrogen gas and 50% by volume of ethylene gas was used in place of the mixed gas composed of 2% by volume of hydrogen gas and 98% by volume of ethylene gas.

### REFERENCE EXAMPLE 3

A composite particle that included silicon oxide and carbon nanofibers was prepared by carrying out the same operations as in Example 27 except that a mixed gas composed of 50% by volume of hydrogen gas and 50% by volume of ethylene gas was used in place of the mixed gas composed of 2% by volume of hydrogen gas and 98% by volume of ethylene gas, and further a carbon reaction vessel was used in place of the quartz reaction vessel.

### REFERENCE EXAMPLE 4

A composite particle that included silicon oxide and carbon nanofibers was prepared by carrying out the same operations as in Example 27 except that a mixed gas composed of 50% by volume of hydrogen gas and 50% by volume of ethylene gas was used in place of the mixed gas composed of 2% by volume of hydrogen gas and 98% by volume of ethylene gas, and further a cast-iron reaction vessel was used in place of the quartz reaction vessel.

### REFERENCE EXAMPLE 5

A composite particle that included silicon oxide and carbon nanofibers was prepared by carrying out the same operations as in Example 27 except that a mixed gas composed of 50% by volume of hydrogen gas and 50% by volume of ethylene gas was used in place of the mixed gas composed of 2% by volume of hydrogen gas and 98% by volume of ethylene gas, and further an alumina reaction vessel was used in place of the quartz reaction vessel.

### [Evaluations]

For each of Examples 27 to 32 and Reference Examples 1 to 5, the production efficiency of the carbon nanofibers and the problematic point are shown in Table 5. The production efficiency of the carbon nanofibers was calculated on the basis of following formula (I):

Production efficiency (% by weight) of carbon nanofibers=100×(weight of produced carbon nanofibers÷weight of active material)

TABLE 5

| | | | CNF | |
|---|---|---|---|---|
| | Hydrogen | | production | |
| | concentration | Reaction | efficiency | Problematic |
| | (vol %) | vessel | (wt %) | point |
| Example 27 | 2 | Quartz | 101 | None |
| Example 28 | 0 | Quartz | 125 | None |
| Example 29 | 5 | Quartz | 92 | None |
| Example 30 | 2 | Carbon | 98 | None |
| Example 31 | 2 | Cast iron | 99 | None |
| Example 32 | 2 | Alumina | 103 | None |
| Referential | 10 | Quartz | 45 | Degradation |
| example 1 | | | | of production |
| | | | | efficiency |
| Referential | 50 | Quartz | 23 | Degradation |
| example 2 | | | | of production |
| | | | | efficiency |
| Referential | 50 | Carbon | 20 | Deterioration |
| example 3 | | | | of vessel |
| Referential | 50 | Cast iron | 25 | Deterioration |
| example 4 | | | | of vessel |
| Referential | 50 | Alumina | 21 | Leak of |
| example 5 | | | | hydrogen gas |

CNF: Carbon nanofiber

As shown in Table 5, the results obtained show that the production efficiency (yield) of the carbon nanofibers was drastically improved in each of Examples 27 to 32 as compared to Reference Examples 1 and 2. In Reference Example 3, there was found the gasification of the carbon that constituted the reaction vessel, due to the effect of the concomitance of hydrogen gas and the catalyst; the reaction vessel was found to suffer a strength degradation to an extreme extent even when the vessel was used in a few runs of experiments.

Also in the cast iron reaction vessel used in Reference Example 4, the carbon component contained in the cast iron was corroded by gasification to lead to the strength degradation of the reaction vessel itself.

In Reference Example 5, a slight leakage of hydrogen gas due to the deterioration of alumina was detected to inhibit satisfactory experimental examinations.

### EXAMPLE 33

A composite particle that included silicon oxide and carbon nanofibers was prepared by carrying out the same operations as in Example 27 except that in 100 g of ion-exchanged water, 1 g of cobalt nitrate hexahydrate (guaranteed grade) manufactured by Kanto Chemical Co., Inc. was dissolved in place of 1 g of nickel nitrate hexahydrate.

### EXAMPLE 34

A composite particle that included silicon oxide and carbon nanofibers was prepared by carrying out the same operations as in Example 27 except that in 100 g of ion-exchanged water, 1 g of iron nitrate nonahydrate (guaranteed grade) manufactured by Kanto Chemical Co., Inc. was dissolved in place of 1 g of nickel nitrate hexahydrate.

### EXAMPLE 35

A composite particle that included silicon oxide and carbon nanofibers was prepared by carrying out the same operations as in Example 27 except that in 100 g of ion-exchanged water, 1 g of hexaammonium heptamolybdate tetrahydrate (guaranteed grade) manufactured by Kanto Chemical Co., Inc. was dissolved in place of 1 g of nickel nitrate hexahydrate.

### EXAMPLE 36

A composite particle that included silicon oxide and carbon nanofibers was prepared by carrying out the same operations as in Example 27 except that in 100 g of ion-exchanged water, 0.5 g of nickel nitrate hexahydrate and 0.5 g of cobalt nitrate hexahydrate, both manufactured by Kanto Chemical Co., Inc. were dissolved in place of 1 g of nickel nitrate hexahydrate.

### COMPARATIVE EXAMPLE 7

An active material that included silicon oxide was prepared by carrying out the same operations as in Example 27 except that nickel nitrate hexahydrate was not dissolved.

### [Evaluations]

For each of Examples 27 and 33 to 36 and Comparative Example 7, the production efficiency of the carbon nanofibers is shown in Table 6. The production efficiency of the carbon nanofibers was calculated on the basis of above formula (I).

TABLE 6

| | | CNF |
|---|---|---|
| | | production |
| | Catalyst | efficiency |
| | element | (wt %) |
| Example 27 | Ni | 101 |
| Example 33 | Co | 103 |
| Example 34 | Fe | 104 |
| Example 35 | Mo | 88 |
| Example 36 | NiCo | 101 |
| Comparative | None | 0 |
| example 7 | | |

CNF: Carbon nanofiber

As shown in Table 6, even when the catalyst type was varied, the production efficiency of the carbon nanofibers was not significantly affected and the yields were high without exception. On the contrary, in Comparative Example 7 where no catalyst was present, it was also revealed that no carbon nanofiber was produced at all.

### EXAMPLE 37

A composite particle that included silicon oxide and carbon nanofibers was prepared by carrying out the same operations as in Example 27 except that ethane gas was used as a carbon-containing gas in place of ethylene gas.

### EXAMPLE 38

A composite particle that included silicon oxide and carbon nanofibers was prepared by carrying out the same operations as in Example 27 except that acetylene gas was used as a carbon-containing gas in place of ethylene gas.

### EXAMPLE 39

A composite particle that included silicon oxide and carbon nanofibers was prepared by carrying out the same operations as in Example 27 except that propane gas was used as a carbon-containing gas in place of ethylene gas.

### EXAMPLE 40

A composite particle that included silicon oxide and carbon nanofibers was prepared by carrying out the same operations as in Example 27 except that propene gas was used as a carbon-containing gas in place of ethylene gas.

### EXAMPLE 41

A composite particle that included silicon oxide and carbon nanofibers was prepared by carrying out the same operations as in Example 27 except that propyne gas was used as a carbon-containing gas in place of ethylene gas.

### EXAMPLE 42

A composite particle that included silicon oxide and carbon nanofibers was prepared by carrying out the same operations as in Example 27 except that allene gas was used as a carbon-containing gas in place of ethylene gas.

### EXAMPLE 43

A composite particle that included silicon oxide and carbon nanofibers was prepared by carrying out the same operations as in Example 27 except that 28% by volume of ethane gas and 70% by volume of ethylene gas were used as carbon-containing gases in place of 98% by volume of ethylene gas.

### EXAMPLE 44

A composite particle that included silicon oxide and carbon nanofibers was prepared by carrying out the same operations as in Example 27 except that 49% by volume of ethane gas and 49% by volume of ethylene gas were used as carbon-containing gases in place of 98% by volume of ethylene gas.

### EXAMPLE 45

A composite particle that included silicon oxide and carbon nanofibers was prepared by carrying out the same operations as in Example 27 except that 70% by volume of ethane gas and 28% by volume of ethylene gas were used as carbon-containing gases in place of 98% by volume of ethylene gas.

### EXAMPLE 46

A composite particle that included silicon oxide and carbon nanofibers was prepared by carrying out the same operations as in Example 27 except that methane gas was used as a carbon-containing gas in place of ethylene gas.

### EXAMPLE 47

A composite particle that included silicon oxide and carbon nanofibers was prepared by carrying out the same operations as in Example 27 except that carbon monoxide gas was used as a carbon-containing gas in place of ethylene gas.

A composite particle that included silicon oxide was prepared by carrying out the same operations as in Example 27 except that a mixed gas composed of hexane and helium was used in place of ethylene gas. Helium gas was mixed as a carrier gas for hexane that is liquid at ordinary temperatures.

### COMPARATIVE EXAMPLE 9

A composite particle that included silicon oxide was prepared by carrying out the same operations as in Example 27 except that a mixed gas composed of benzene and helium was used in place of ethylene gas. Helium gas was mixed as a carrier gas for benzene that is liquid at ordinary temperatures.

For each of Examples 27 and 37 to 47 and Comparative Examples 8 and 9, the production efficiency of the carbon nanofibers is shown in Table 7. The production efficiency of the carbon nanofibers was calculated on the basis of above formula (1).

TABLE 7

| | | CNF |
|---|---|---|
| | | production |
| | | efficiency |
| | Gas | (wt %) |
| Example 27 | Ethylene | 101 |
| Example 37 | Ethane | 82 |
| Example 38 | Acetylene | 92 |
| Example 39 | Propane | 95 |
| Example 40 | Propene | 103 |
| Example 41 | Propyne | 105 |
| Example 42 | Allene | 106 |
| Example 43 | Ethane/ethylene = 28/70 | 96 |
| Example 44 | Ethane/ethylene = 49/49 | 92 |
| Example 45 | Ethane/ethylene = 70/28 | 86 |
| Example 46 | Methane | 58 |
| Example 47 | Carbon monoxide | 58 |
| Comparative | Hexane/helium = 50/50 | 1 |
| example 8 | | |
| Comparative | Benzene/helium = 50/50 | 0 |
| example 9 | | |

CNF: Carbon nanofiber

As shown in Table 7, each of the carbon-containing gases used in Example 27 and 37 to 47 gave a high production efficiency of the carbon nanofibers as compared with any of the gases used in Comparative Examples 8 and 9. Additionally, there was found a tendency to decrease the production efficiency of the carbon nanofibers when a raw material gas that included a saturated hydrocarbon gas was used in a large proportion.

The compounds that were used in Comparative Examples 8 and 9 and each contained 6 carbon atoms are high in polymerizability. In particular, for benzene, condensation polymerization reaction proceeds easily without catalyst. Consequently, no carbon nanofiber was formed with the catalyst as the starting points, but carbon coating or carbide was formed on the surface of the active material. Accordingly, the production of carbon nanofibers was not identified.

### EXAMPLE 48

A composite particle that included silicon oxide and carbon nanofibers was prepared by carrying out the same operations as in Example 27 except that the synthesis of the carbon nanofibers was carried out at 400° C. instead of 550° C.

### EXAMPLE 49

A composite particle that included silicon oxide and carbon nanofibers was prepared by carrying out the same operations as in Example 27 except that the synthesis of the carbon nanofibers was carried out at 600° C. instead of 550° C.

### EXAMPLE 50

A composite particle that included silicon oxide and carbon nanofibers was prepared by carrying out the same operations as in Example 27 except that the synthesis of the carbon nanofibers was carried out at 750° C. instead of 550° C.

For each of Examples 27 and 48 to 50, the production efficiency of the carbon nanofibers is shown in Table 8. The production efficiency of the carbon nanofibers was calculated on the basis of above formula (1).

TABLE 8

| | | CNF |
|---|---|---|
| | Synthesis | production |
| | temperature | efficiency |
| | (° C.) | (wt %) |
| Example 27 | 550 | 101 |
| Example 48 | 400 | 92 |
| Example 49 | 600 | 100 |
| Example 50 | 750 | 79 |

CNF: Carbon nanofiber

As shown in Table 8, within the synthesis temperature range covering Examples 27 and 48 to 50, a high production efficiency of the carbon nanofibers was obtained in any of these Examples.

### EXAMPLE 51

Oxidation treatment was applied at 1000° C. for 1 hour to Si pulverized to 10 μm or less, manufactured by Kojundo Chemical Laboratory Co., Ltd. A composite particle that included silicon and carbon nanofibers was prepared by carrying out the same operations as in Example 27 except that the thus oxidation-treated silicon particle was used as active material in place of SiO. The composite particle thus obtained can be used, for example, as a negative electrode material for a non-aqueous electrolyte secondary battery.

### EXAMPLE 52

Oxidation treatment was applied at 150° C. for 30 minutes to Sn pulverized to 10 μm or less, manufactured by Kojundo Chemical Laboratory Co., Ltd. A composite particle that included tin and carbon nanofibers was prepared by carrying out the same operations as in Example 27 except that the thus oxidation-treated tin particle was used as active material in place of SiO. The composite particle thus obtained can be used, for example, as a negative electrode material for a non-aqueous electrolyte secondary battery.

### EXAMPLE 53

A composite particle that included tin monoxide and carbon nanofibers was prepared by carrying out the same operations as in Example 27 except that SnO pulverized to 10 μm or less, manufactured by Kojundo Chemical Laboratory Co., Ltd., was used as active material in place of SiO. The composite particle thus obtained can be used, for example, as a negative electrode material for a non-aqueous electrolyte secondary battery.

### EXAMPLE 54

A composite particle that included tin dioxide and carbon nanofibers was prepared by carrying out the same operations as in Example 27 except that SnO₂ pulverized to 10 μm or less, manufactured by Kojundo Chemical Laboratory Co., Ltd., was used as active material in place of SiO. The composite particle thus obtained can be used, for example, as a negative electrode material for a non-aqueous electrolyte secondary battery.

### EXAMPLE 55

Oxidation treatment was applied at 600° C. for 30 minutes to Ge pulverized to 10 μm or less, manufactured by Kojundo Chemical Laboratory Co., Ltd. A composite particle that included germanium and carbon nanofibers was prepared by carrying out the same operations as in Example 27 except that the thus oxidation-treated germanium was used as active material in place of SiO. The composite particle thus obtained can be used, for example, as a negative electrode material for a non-aqueous electrolyte secondary battery.

### EXAMPLE 56

A composite particle that included germanium monoxide and carbon nanofibers was prepared by carrying out the same operations as in Example 27 except that GeO pulverized to 10 μm or less, manufactured by Kojundo Chemical Laboratory Co., Ltd., was used as active material in place of SiO. The composite particle thus obtained can be used, for example, as a negative electrode material for a non-aqueous electrolyte secondary battery.

### EXAMPLE 57

A composite particle that included germanium dioxide and carbon nanofibers was prepared by carrying out the same operations as in Example 27 except that GeO₂ pulverized to 10 μm or less, manufactured by Kojundo Chemical Laboratory Co., Ltd., was used as active material in place of SiO. The composite particle thus obtained can be used, for example, as a negative electrode material for a non-aqueous electrolyte secondary battery.

### EXAMPLE 58

A composite particle that included lithium cobaltate and carbon nanofibers was prepared by carrying out the same operations as in Example 27 except that LiCoO₂ pulverized to 10 μm or less was used as active material in place of SiO. The composite particle thus obtained can be used, for example, as a positive electrode material for a non-aqueous electrolyte secondary battery.

### EXAMPLE 59

A composite particle that included lithium nickelate and carbon nanofibers was prepared by carrying out the same operations as in Example 27 except that LiNiO₂ pulverized to 10 μm or less was used as active material in place of SiO. The composite particle thus obtained can be used, for example, as a positive electrode material for a non-aqueous electrolyte secondary battery.

### EXAMPLE 60

A composite particle that included lithium manganate and carbon nanofibers was prepared by carrying out the same operations as in Example 27 except that LiMn₂O₄ pulverized to 10 μm or less was used as active material in place of SiO. The composite particle thus obtained can be used, for example, as a positive electrode material for a non-aqueous electrolyte secondary battery.

### EXAMPLE 61

A composite particle that included LiFePO₄ and carbon nanofibers was prepared by carrying out the same operations as in Example 27 except that LiFePO₄ pulverized to 10 μm or less was used as active material in place of SiO. The composite particle thus obtained can be used, for example, as a positive electrode material for a non-aqueous electrolyte secondary battery.

### EXAMPLE 62

A composite particle that included ruthenium oxide and carbon nanofibers was prepared by carrying out the same operations as in Example 27 except that RuO₂ pulverized to 10 μm or less, manufactured by Kojundo Chemical Laboratory Co., Ltd., was used as active material in place of SiO. The composite particle thus obtained can be used, for example, as an electrode material for an electrochemical capacitor.

### EXAMPLE 63

A composite particle that included manganese dioxide and carbon nanofibers was prepared by carrying out the same operations as in Example 27 except that MnO₂ pulverized to 10 μm or less, manufactured by Kojundo Chemical Laboratory Co., Ltd., was used as active material in place of SiO. The composite particle thus obtained can be used, for example, as an electrode material for an electrochemical capacitor.

### REFERENCE EXAMPLE 6

A composite particle that included silicon and carbon nanofibers was prepared by carrying out the same operations as in Example 27 except that Si pulverized to 10 μm or less, manufactured by Kojundo Chemical Laboratory Co., Ltd., was used as it was as active material in place of SiO. The composite particle thus obtained can be used, for example, as a negative electrode material for a non-aqueous electrolyte secondary battery.

### REFERENCE EXAMPLE 7

An active material that included silicon oxide was prepared by carrying out the same operations as in Example 27 except that a mixed gas composed of 50% by volume of hydrogen gas and 50% by volume of ethylene gas was used in place of the mixed gas composed of 2% by volume of hydrogen gas and 98% by volume of ethylene gas and SnO₂ pulverized to 10 μm or less was used as active material in place of SiO.

For each of Examples 27 and 51 to 63 and Reference Examples 6 and 7, the production efficiency of the carbon nanofibers and the occurrence/nonoccurrence of the structure variation in the active material are shown in Table 9. The production efficiency of the carbon nanofibers was calculated on the basis of above formula (1). As for the structure variation of the active material, the occurrence/nonoccurrence of the crystal structure variation due to thermal history and hydrogen gas reduction were examined on the basis of the powder X-ray diffraction measurements made for the active material before and after the growth of the carbon nanofibers.

TABLE 9

| | | | Structure | CNF |
|---|---|---|---|---|
| | Hydrogen | | variation of | production |
| | concentration | | active | efficiency |
| | (vol %) | Active material | material | (wt %) |
| Example 27 | 2 | SiO | Not occurred | 101 |
| Example 51 | 2 | Surface- | Not occurred | 152 |
| | | oxidized Si | | |
| Example 52 | 2 | Surface- | Not occurred | 60 |
| | | oxidized Sn | | |
| Example 53 | 2 | SnO | Not occurred | 56 |
| Example 54 | 2 | SnO₂ | Not occurred | 48 |
| Example 55 | 2 | Surface- | Not occurred | 83 |
| | | oxidized Ge | | |
| Example 56 | 2 | GeO | Not occurred | 79 |
| Example 57 | 2 | GeO₂ | Not occurred | 71 |
| Example 58 | 2 | LiCoO₂ | Not occurred | 55 |
| Example 59 | 2 | LiNiO₂ | Not occurred | 52 |
| Example 60 | 2 | LiMn₂O₄ | Not occurred | 42 |
| Example 61 | 2 | LiFePO₄ | Not occurred | 39 |
| Example 62 | 2 | RuO₂ | Not occurred | 43 |
| Example 63 | 2 | MnO₂ | Not occurred | 52 |
| Referential | 2 | Si | Not occurred | 50 |
| example 6 | | | | |
| Referential | 50 | SnO₂ | Occurred | 0 |
| example 7 | | | | |

CNF: Carbon nanofiber

As shown in Table 9, for any of the active materials used in Examples 27 and 51 to 63, the production of the carbon nanofibers was able to be identified. There was found a tendency that the production efficiency of the carbon nanofibers was dependent on the formula weight of the material (active material) capable of electrochemically storing electric capacity. As the formula weight became larger, the production efficiency of the carbon nanofibers became smaller. As the formula weight became smaller, the production efficiency of the carbon nanofibers became higher. From a relative point of view, the production amounts of the carbon nanofibers are approximately comparable with each other although there are variations to some extents due to the effects of the specific surface areas and the like.

On the other hand, in Reference Example 6, namely, in the case where was used the Si that did not include the oxide on the surface thereof, there was obtained a result that the production efficiency of the carbon nanofibers was reduced by half as compared to Example 51. From this fact, it is inferred that the presence of the oxide in the surface layer of an active material improves the reduction performance of the catalyst and the catalytic activity involved therein, and consequently improves the production efficiency of the carbon nanofibers.

Further, in Reference Example 7 where the concentration of the hydrogen in the raw material gas was made higher and tin dioxide was used as a raw material, the reduction reaction of tin dioxide itself due to hydrogen gas and thermal history was identified. The cause for no identification of the production of the carbon nanofibers is conceivably such that the reduction reaction of tin oxide detached the catalyst from the surface of the active material, and furthermore, the water produced by the reduction reaction oxidized and thereby deactivated the catalyst.

### EXAMPLE 64

An electrode plate for a non-aqueous electrolyte secondary battery was prepared by using the composite particle prepared in Example 27. Specifically, 100 parts by weight of the composite particle was mixed with 10 parts by weight of a binder made of a vinylidene fluoride resin and an appropriate amount of N-methyl-2-pyrrolidone (NMP) to prepare a material mixture slurry. The slurry was cast on both sides of a 10 μm thick Cu foil and dried; thereafter the material mixture was rolled to yield an electrode plate. The material mixture density of the obtained electrode plate was 1.2 g/cm³.

The electrode plate was sufficiently dried in an oven set at 80° C. to yield a working electrode. By using a lithium metal foil as the counter electrode for the working electrode, a coin-shaped lithium ion battery regulated in capacity by the working electrode was prepared. As the non-aqueous electrolyte, there was used an electrolyte in which LiPF₆ was dissolved in a concentration of 1.0 mol/L in a 1:1 (volume ratio) mixed solvent of ethylene carbonate and diethyl carbonate.

### EXAMPLE 65

A coin-shaped lithium ion battery was prepared by carrying out the same operations as in Example 64 except that the composite particle prepared in Example 51 was used in place of the composite particle prepared in Example 27.

### COMPARATIVE EXAMPLE 10

Here, 100 parts by weight of acetylene black as a conductive material was added to and mixed with 100 parts by weight of SiO pulverized to 10 μm or less. A coin-shaped lithium ion battery was prepared by carrying out the same operations as in Example 64 except that the mixture thus obtained was used in place of the composite particle prepared in Example 27.

### COMPARATIVE EXAMPLE 11

A coin-shaped lithium ion battery was prepared by carrying out the same operations as in Example 64 except that the composite particle prepared in Reference Example 6 was used in place of the composite active material prepared in Example 27.

For each of the coin-shaped lithium ion batteries obtained in Examples 64 and 65 and Comparative Examples 10 and 11, the initial discharge efficiency and the cycle efficiency are shown in Table 10.

Here, it is to be noted that the initial discharge efficiency is defined as follows: a battery is charged at a rate of 0.2 C and is discharged at a rate of 1 C or 2 C, and the ratio of the 2 C discharge capacity to the 1 C discharge capacity is defined as the initial discharge efficiency. The initial discharge efficiencies were calculated on the basis of the following formula:

Initial discharge efficiency (%)=(2 C discharge capacity÷1 C discharge capacity)×100

The cycle efficiency is defined as the ratio of the discharge capacity after 100 repeated charge/discharge cycles at a charge/discharge rate of 1 C to the initial discharge capacity obtained at the same charge/discharge rate. The cycle efficiencies were calculated on the basis of the following formula:

Cycle efficiency (%)=(discharge capacity after 100 cycles÷initial discharge capacity)×100

TABLE 10

| | | Initial discharge | Cycle |
|---|---|---|---|
| | | efficiency | efficiency |
| | Electrode material | (%) | (%) |
| Example 64 | CNF-coated SiO | 92 | 90 |
| Example 65 | CNF-coated Si | 80 | 72 |
| | (surface oxidized) | | |
| Comparative | SiO | 30 | 0 |
| example 10 | | | |
| Comparative | CNF-coated Si | 75 | 5 |
| example 11 | (surface non-oxidized) | | |

CNF: Carbon nanofiber

As shown in Table 10, there were obtained the results that the initial discharge efficiencies and the cycle efficiencies of Examples 64 and 65 were superior to those of Comparative Examples 10 and 11. It is conceivable that the growth of the carbon nanofibers on the surface of a material (active material) capable of electrochemically storing electric capacity permitted forming a strong electrically conductive network, which led to the improvements of the initial discharge characteristics and the cycle efficiency.

As can be seen from the results of Example 65 and Comparative Example 11, better battery performances are obtained by use of an active material that includes an oxide in the surface layer thereof. This is probably because the catalyst element was supported strongly on the surface of the active material owing to the oxide located in the surface layer of the active material and consequently carbon nanofibers were grown more uniformly.

### EXAMPLE 66

An electrode plate for a non-aqueous electrolyte secondary battery was prepared by using the composite particle prepared in Example 58. Specifically, 100 parts by weight of the composite particle was mixed with 10 parts by weight of a binder made of a vinylidene fluoride resin and an appropriate amount of NMP to prepare a material mixture slurry. The slurry was cast on both sides of a 10 μm thick Al foil and dried; thereafter the material mixture was rolled to yield an electrode plate. The material mixture density of the obtained electrode plate was 2.8 g/cm³.

The electrode plate was sufficiently dried in an oven set at 80° C. to yield a working electrode. By using a lithium metal foil as the counter electrode for the working electrode, a coin-shaped lithium ion battery regulated in capacity by the working electrode was prepared. As the non-aqueous electrolyte, there was used an electrolyte in which LiPF₆ was dissolved in a concentration of 1.0 mol/L in a 1:1 (volume ratio) mixed solvent of ethylene carbonate and diethyl carbonate.

### COMPARATIVE EXAMPLE 12

Here, 55 parts by weight of acetylene black as a conductive material was added to and mixed with 100 parts by weight of LiCoO₂ pulverized to 10 μm or less. A coin-shaped lithium ion battery was prepared by carrying out the same operations as in Example 66 except that the mixture thus obtained was used in place of the composite particle prepared in Example 58.

For each of the batteries prepared in Example 66 and Comparative Example 12, the initial discharge efficiency and the cycle efficiency are shown in Table 11.

Here, it is to be noted that the initial discharge efficiency is defined as follows: a battery is charged at a rate of 0.2 C and is discharged at a rate of 1 C or 2 C, and the ratio of the 2 C discharge capacity to the 1 C discharge capacity is defined as the initial discharge efficiency. The initial discharge efficiencies were calculated on the basis of the following formula:

Initial discharge efficiency (%)=(2 C discharge capacity÷1 C discharge capacity)×100

The cycle efficiency is defined as the ratio of the discharge capacity after 500 repeated charge/discharge cycles at a charge/discharge rate of 1 C to the initial discharge capacity obtained at the same charge/discharge rate. The cycle efficiencies were calculated on the basis of the following formula:

Cycle efficiency (%)=(discharge capacity after 500 cycles÷initial discharge capacity)×100

TABLE 11

| | | Initial | |
|---|---|---|---|
| | | discharge | Cycle |
| | | efficiency | efficiency |
| | Electrode material | (%) | (%) |
| Example 66 | CNF-coated LiCoO₂ | 98 | 93 |
| Comparative | LiCoO₂ | 88 | 70 |
| example 12 | | | |

CNF: Carbon nanofiber

As shown in Table 11, the initial discharge efficiency and the cycle efficiency obtained in Example 66 were superior to those of Comparative Example 12. It is conceivable that the growth of the carbon nanofibers on the surface of a material capable of electrochemically storing electric capacity permitted forming a strong electrically conductive network, which led to the improvements of the initial discharge characteristics and the cycle efficiency.

### EXAMPLE 67

An electrode plate for an electric double layer capacitor was prepared by using the composite particle prepared in Example 62. Specifically, 100 parts by weight of the composite particle was mixed with 7 parts by weight of a binder made of polytetrafluoroethylene (PTFE) and an appropriate amount of water to prepare a material mixture slurry. The slurry was cast on both sides of a 10 μm thick SUS foil and dried; thereafter the material mixture was rolled to yield an electrode plate.

The electrode plate was sufficiently dried in an oven set at 150° C. A pair of electrodes were prepared, with which a cellulose separator was sandwiched to prepare a coin-shaped electric double layer capacitor. As the electrolyte, there was used an electrolyte in which ethyl methyl imidazolium tetrafluoroborate was dissolved in sulfolane in a concentration of 1.5 mol/L.

### COMPARATIVE EXAMPLE 13

Here, 43 parts by weight of acetylene black as a conductive material was added to and mixed with 100 parts by weight of RuO₂ pulverized to 10 μm or less. A coin-shaped electric double layer capacitor was prepared by carrying out the same operations as in Example 67 except that the mixture thus obtained was used in place of the composite particle prepared in Example 62.

The electric double layer capacitors obtained in Example 67 and Comparative Example 13 were subjected to an impedance measurement at 1 kHz. The results obtained are shown in Table 12.

TABLE 12

| | | Impedance |
|---|---|---|
| | Electrode | at 1 kHz |
| | material | (mΩ) |
| Example 67 | CNF-coated | 25.3 |
| | RuO₂ | |
| Comparative | RuO₂ | 38.3 |
| example 13 | | |

CNF: Carbon nanofiber

As shown in Table 12, the impedance at 1 kHz obtained in Example 67 was lower than that in Comparative Example 13. It is interpreted that the growth of the carbon nanofibers on the surface of a material capable of electrochemically storing electric capacity permitted forming a strong electrically conductive network, which led to the reduction of the interface resistance component.

### INDUSTRIAL APPLICABILITY

The present invention can be generally applied to active material particles that are used for electrodes of electrochemical elements. The present invention provides a composite particle (electrode material) that gives a non-aqueous electrolyte secondary battery or a capacitor having excellent initial chare/discharge characteristics or excellent cycle characteristics. The present invention is effective for the improvement of any of the positive electrode active material and the negative electrode active material of a non-aqueous electrolyte secondary battery, and further, the active material (dielectric material) of a capacitor, and the present invention does not impose any constraint on the types of the active materials.

The production method of the present invention makes is possible to efficiently grow carbon nanofibers on the surface of an active material. Accordingly, the production method of the present invention is useful as a production method of an active material that is to be used for the electrodes of electrochemical elements such as batteries and electrochemical capacitors.

1. A composite particle for an electrode comprising an active material particle, carbon nanofibers bonded to the surface of said active material particle and a catalyst element for promoting the growth of the carbon nanofibers, wherein said active material particle comprises an electrochemically active phase.

2. The composite particle for an electrode according to claim 1, wherein said catalyst element is at least one selected from the group-consisting of Au, Ag, Pt, Ru, Ir, Cu, Fe, Co, Ni, Mo and Mn.

3. The composite particle for an electrode according to claim 1, wherein said catalyst element is located at least in the surface layer of said active material particle or at the tip of said carbon nanofibers.

4. The composite particle for an electrode according to claim 1, wherein said catalyst element is present in a state of a metal particle and/or a metal oxide particle of 1 nm to 1000 nm in particle size in the surface layer of said active material particle.

5. The composite particle for an electrode according to claim 1, wherein at least one end of said carbon nanofibers is chemically bonded to the surface of said active material particle.

6. The composite particle for an electrode according to claim 1, wherein said carbon nanofibers have a fiber length of 1 nm to 1 mm.

7. The composite particle for an electrode according to claim 1, wherein said carbon nanofibers comprise fibers of 1 nm to 40 nm in fiber diameter.

8. The composite particle for an electrode according to claim 1, wherein said carbon nanofibers comprise at least one selected from the group consisting of tubular carbon, accordion-shaped carbon, plate-shaped carbon and herringbone-shaped carbon.

9. The composite particle for an electrode according to claim 1, wherein said electrochemically active phase comprises at least one metal or semimetal element selected from the group consisting of the elements of the 3B, 4B and 5B groups in the periodic table, and the phase comprising said metal or semimetal element is a compound, an alloy or an elementary substance thereof.

10. The composite particle for an electrode according to claim 9, wherein said compound is at least one selected from the group consisting of an oxide, a nitride, an oxynitride, a carbide and a sulfide.

11. The composite particle for an electrode according to claim 9, wherein said metal or semimetal element is at least one selected from the group consisting of Si, Sn and Ge, and said compound is at least one selected from the group consisting of an oxide, a nitride and an oxynitride.

12. The composite particle for an electrode according to claim 1, wherein said active material particle comprises a core formed of an elementary substance of at least one metal or semimetal element selected from the group consisting of the elements of the 3B, 4B and 5B groups in the periodic table, and an oxide layer covering the surface of said core.

13. The composite particle for an electrode according to claim 1, wherein said electrochemically active phase is formed of a lithium-containing transition metal oxide having-a layered-structure, and said lithium-containing transition metal oxide comprises at least one metal element selected from the group consisting of Cu, Fe, Co, Ni, Mo and Mn.

14. A method for producing a composite particle for an electrode, the method comprising:
a step A of preparing an active material particle comprising an electrochemically active phase and having, at least on the surface thereof, a catalyst element for promoting the growth of carbon nanofibers;
a step B of growing the carbon nanofibers on the surface of said active material particle in an atmosphere comprising a carbon-containing gas; and
a step C of baking said active material particle with the carbon nanofibers bonded thereto at 400° C. or higher and 1600° C. or lower in an inert gas atmosphere.

15. The method for producing a composite particle for an electrode according to claim 14, wherein the step A comprises a step of supporting, on the surface of the particle comprising an electrochemically active phase, a particle comprising at least one metal element selected from the group consisting of Au, Ag, Pt, Ru, Ir, Cu, Fe, Co, Ni, Mo and Mn.

16. The method for producing a composite particle for an electrode according to claim 14, wherein the step A comprises a step of reducing the surface of the particle comprising the electrochemically active phase including at least one metal element selected from the group consisting of Cu, Fe, Co, Ni, Mo and Mn.

17. The method for producing a composite particle for an electrode according to claim 14, wherein the step A comprises a step of synthesizing a particle of an alloy of at least one metal or semimetal element selected from the group consisting of the elements of the 3B, 4B and 5B groups in the periodic table and at least one metal element selected from the group consisting of Cu, Fe, Co, Ni, Mo and Mn.

18. The method for producing a composite particle for an electrode according to claim 14, further comprising a step of heat treating in air, after the step C, said composite particle at 100° C. or higher and 400° C. or lower.

19. The method for producing a composite particle for an electrode according to claim 14, wherein said catalyst element is Ni, said carbon-containing gas is ethylene, and said carbon nanofibers are of a herringbone shape.

20. A secondary battery comprising a chargeable and dischargeable positive electrode, a chargeable and dischargeable negative electrode, and a non-aqueous electrolyte, wherein at least one of said positive electrode and said negative electrode comprises the composite particle according to claim 1.

21. An electrochemical capacitor comprising a pair of polarizable electrodes, a separator interposed between the two electrodes and an aqueous or non-aqueous electrolyte, wherein said polarizable electrodes comprise the composite particle according to claim 1.

22. A method for producing a composite particle for an electrode, the method comprising:
a step of supporting on the surface of an active material a catalyst element for promoting the growth of carbon nanofibers; and
a step of growing carbon nanofibers on the surface of said active material by bringing the active material that supports said catalyst element into contact with a raw material gas, wherein:
said active material comprises an oxide;
said raw material gas is a carbon-containing gas or a mixed gas composed of a carbon-containing gas and hydrogen gas;
said carbon-containing gas is at least one selected from the group consisting of carbon monoxide (CO), a saturated hydrocarbon gas represented by CₙH₂ₙ₊₂ (n≧1), an unsaturated hydrocarbon gas represented by CₙH₂ₙ (n≧2) and an unsaturated hydrocarbon gas represented by CₙH₂ₙ₋₂ (n≧2); and
the content of said hydrogen gas accounts for less than 5% by volume of said mixed gas.

23. The method for producing a composite particle for an electrode according to claim 22, wherein the surface layer of said active material comprises an oxide.

24. The method for producing a composite particle for an electrode according to claim 22, wherein said catalyst element is at least one selected from the group consisting of Au, Ag, Pt, Ru, Ir, Cu, Fe, Co, Ni, Mo and Mn.

25. The method for producing a composite particle for an electrode according to claim 22, wherein the carbon nanofibers bonded to the surface of said active material are grown by introducing said raw material gas and said active material that supports the catalyst element into a reaction vessel, and by maintaining the temperature inside said reaction vessel at 400 to 750° C.

26. The method for producing a composite particle for an electrode according to claim 25, wherein said reaction vessel is formed of at least one material selected from the group consisting of cast iron, carbon and alumina.

27. The method for producing a composite particle for an electrode according to claim 22, wherein the active material that supports said catalyst element in a state of a salt or a compound is brought into contact with said raw material gas.
